(19) United States
(12) Patent Application Publication
(10) Pub. No.: US 2016/0063859 A1
(43) Pub. Date: Mar. 3, 2016

(54) Dual Mode Traffic Intersection, System for Directing Traffic at a Traffic Intersection, and Method Therefor

(71) Applicant: Valiant Yuk Yuen Leung, New South Wales (AU)

(72) Inventor: Valiant Yuk Yuen Leung, New South Wales (AU)

(21) Appl. No.: 14/839,939

(22) Filed: Aug. 29, 2015

(30) Foreign Application Priority Data
Aug. 29, 2014 (AU) 2014903453

(51) Int. Cl. G08G 1/081; E01C 17/00; E01C 1/00

(52) U.S. Cl. CPC G08G 1/081; E01C 1/002; E01C 17/00

(57) ABSTRACT

A traffic intersection is configured to allow for the splitting of turning left lane from the other lanes at a region distal from the intersection region at a crossover zone to reduce bottlenecks at the intersection region itself and smoothes the flow of traffic. Also provided are a traffic guidance system, a traffic signaling arrangement, a pedestrian crossing, a pedestrian crossing guidance system, a directional indicator arrangement, a method of marking a traffic intersection and a method of determining a marking protocol for use at or with the traffic intersection.

### CROSS-REFERENCE TO RELATED APPLICATIONS

This application claims the priority, under 35 U.S.C. §119, of copending AU Provisional Patent Application No. 2014903453, filed Aug. 29, 2014; the prior application is herewith incorporated by reference herein in its entirety.

### STATEMENT REGARDING FEDERALLY SPONSORED RESEARCH OR DEVELOPMENT

Not Applicable

### FIELD OF THE INVENTION

The present systems and methods lies in the field of traffic management. The present disclosure relates to a traffic intersection, a system for directing traffic and a method therefor.

The invention has been developed primarily for use in/with regard to traffic intersections and traffic flow on congested roads, and will be described hereinafter with reference to this application. However, it will be appreciated that the invention is not limited to this particular field of use.

### BACKGROUND OF THE INVENTION

Increasingly large cities worldwide have led to increased traffic congestion. Larger roads are being designed and created, with more lanes to them, to handle increasingly larger numbers of vehicles. However, where such larger roads intersect, each with many lanes, the flow of traffic can be interrupted by a long waiting period at traffic lights. This is typically caused by the cars having to wait for all the various combinations and permutations of signals to be processed for cars approaching from different sides, and that are turning in various different directions or proceeding straight. These long waiting periods may create additional congestion on busy roads.

It is to be understood that, if any prior art information is referred to herein, such reference does not constitute an admission that the information forms part of the common general knowledge in the art, in Australia or any other country.

Thus, a need exists to overcome the problems with the prior art systems, designs, and processes as discussed above.

### SUMMARY OF THE INVENTION

The systems and methods described provide a traffic intersection, a system for directing traffic and a method therefor that overcome the hereinafore-mentioned disadvantages of the heretofore-known devices and methods of this general type and that overcome or substantially ameliorate at least some of the deficiencies of the prior art, or to at least provide an alternative.

For Left-Side Drive Roads

According to a first aspect of the present invention, the invention may be said to broadly comprise a traffic intersection located at an intersection of two multilane roads, each road comprising a plurality of traffic lanes spaced one vehicle spacing apart, the traffic intersection comprising:

a) an intersection region wherein the surface area of the intersecting roads overlap;

b) a proximate region in which each road approaching the intersection includes at least:
i. at least one turning right lane for guiding vehicles to turn left at the intersection onto the intersecting road;
ii. at least one going straight lane for guiding vehicles to move straight through the intersection on the same road; and
iii. the turning right lane being configured to split from the going straight lane in the proximate region by crossing through a crossover zone, so that vehicles travelling straight through the intersection in an opposite direction along the same road are guided to move between the turning right lane and the going straight lane.

In one embodiment, the proximate region comprises a going straight receiving lane that extends between the turning right lane and the going straight lane, for receiving vehicles moving straight across the intersection region from an opposed side.

In one embodiment, each of the going straight lanes is configured to guide vehicles to move at least one or more vehicle spacing to the right in the intersection region.

In one embodiment, each of the going straight lanes is configured to guide vehicles to the crossover zone, to allow vehicles moving straight through the intersection region to cross the crossover zone while moving at least one vehicle spacing to the left.

In one embodiment, the proximate region further comprises at least one turning left lane for guiding vehicles to turn left at the intersection region onto the intersecting road.

In one embodiment, the going straight lane in the proximate region is also configured as a turning left lane for guiding vehicles to turn left at the intersection region onto the intersecting road.

In one embodiment, the traffic intersection comprises visual signaling devices configured for safely directing vehicles on the roads through the intersection region.

In one embodiment, the visual signaling devices are operable in one of only two modes of operation.

In one embodiment, the visual signaling devices are operable in a go condition and a stop condition.

In one embodiment, the visual signaling device is operable in one of only three modes of operation.

In one embodiment, the visual signaling devices are operable in a go condition, slow condition and a stop condition.

In one embodiment, the visual signaling devices are configured for safely directing pedestrians across at least one of the roads at the proximate region.

In one embodiment, the traffic intersection comprises at least one pedestrian island located between two adjacent lanes in a proximate region.

In one embodiment, at least one pedestrian island is located between two adjacent lanes in each proximate region.

In one embodiment, at least one pedestrian island is located to the right of the turning right lane, when viewed from the direction of the turning right lane.

In one embodiment, the proximate region further comprises at least one receiving lane configured for receiving and guiding one or both selected from:

a) vehicles turning right from the intersecting road; and

b) vehicles turning left from the intersecting road

In one embodiment, the proximate region comprises a plurality of receiving lanes.

In one embodiment, the proximate region comprises at least a first receiving lane configured for receiving and guiding a vehicle turning right from the intersecting road, and at least a second receiving lane configured for receiving and guiding a vehicle turning left from the intersecting road.

In one embodiment, the turning right lane is configured to split from the other lanes in the proximate region by crossing through a crossover zone so that going straight lanes for guiding vehicles moving straight across the intersection from the opposing side extends between the turning right lane and the going straight lane.

In one embodiment, the traffic intersection comprises an intermediate visual signaling arrangement configured for visually signaling one or more selected from a vehicle and a bicycle in the proximate region approaching the crossover zone.

In one embodiment, the intermediate visual signaling arrangement is one or more selected from road marking and a signaling device.

In one embodiment, the signaling device is a traffic light.

In one embodiment, the traffic intersection comprises a plurality of bicycle lanes.

In one embodiment, the proximate region is configured to present:

a) at least one turning right bicycle lane associated with the turning right lane, the turning right bicycle land being configured for guiding bicycles to turn left at the intersection onto the intersecting road;

b) at least one going straight bicycle lane associated with the going straight lane, the going straight bicycle lane being configured for guiding bicycles to move straight through the intersection on the same road;

c) the turning right bicycle lane associated with the turning right lane, the turning right bicycle lane being configured to split from the going straight bicycle lane in the proximate region by crossing through a crossover zone, so that vehicles travelling straight through the intersection in an opposite direction along the same road guided to move between the turning right lane and the going straight bicycle lane.

In one embodiment, the proximate region is configured to present a turning left bicycle lane associated with the turning left lane, the turning left bicycle land being configured for guiding bicycles to turn left at the intersection region onto the intersecting road.

In one embodiment, in a region distal to the crossover zone, the traffic intersection comprises traffic intersection comprises at least a pair of bicycle lanes configured for guiding bicycles in opposite directions.

In one embodiment, the bicycle lanes in the region distal to the crossover zone extend centrally along the road.

In one embodiment, the proximate region comprises at least one turning right receiving bicycle lane associated with the first receiving lane, the bicycle turning right receiving lane being configured for receiving and guiding a bicycle turning right from the intersecting road.

In one embodiment, the proximate region comprises at least one turning left receiving bicycle lane associated with the second receiving lane the bicycle turning left receiving lane being configured for receiving and guiding a bicycle turning left from the intersecting road.

In one embodiment, the proximate region comprises at least one going straight receiving bicycle lane associated with the going straight receiving lane, the bicycle going straight receiving lane being configured for receiving and guiding a bicycle going straight over the intersection.

In one embodiment, the traffic intersection comprises bicycle signaling arrangements configured for guiding a bicycle travelling along one or more selected from the turning right bicycle lane, the going straight bicycle lane and the turning left bicycle lane safely through the intersection region

In one embodiment, the traffic intersection comprises a bicycle signaling arrangement configured for signaling to a bicycle in a bicycle lane approaching the intersection region to guide the bicycle safely through the intersection region.

In one embodiment, the bicycle signaling arrangement is a bicycle signaling device.

In one embodiment, the traffic intersection comprises bicycle storage zones associated with the bicycle lanes in the region distal to the crossover zone.

In one embodiment, the road in the region distal to the crossover zone is configured for providing one or more selected from:

a) parking bays;

b) bicycle hire zones;

c) bus only lanes;

d) bus stop zones; and

e) a taxi rank.

In one embodiment, the traffic intersection comprises bicycle signaling arrangements for visually signaling bicycles in one or more selected from the going straight bicycle lane, the turning right bicycle lane and the turning left bicycle lane to safely guide a bicycle through the intersection region.

In one embodiment, the crossover zone is adapted to allow for one or more selected from the following:

a) the crossing of vehicles in the going straight lane with bicycles in the turning right bicycle lane;

b) the crossing of vehicles in the turning left lane with vehicles in the going straight receiving lane;

c) the crossing of vehicles in the turning left lane with bicycles in the going straight receiving bicycle lane;

d) the crossing of vehicles in the turning left lane with bicycles in the turning right bicycle lane;

e) the crossing of vehicles in the turning left lane with bicycles in the going straight bicycle lane;

f) the crossing of bicycles in the turning left bicycle lane with bicycles in the going straight receiving bicycle lane;

g) the crossing of bicycles in the turning left bicycle lane with vehicles in the going straight receiving lane;

h) the crossing of vehicles in the turning left receiving lane with bicycles in the turning right receiving bicycle lane;

i) the crossing of vehicles in the turning left receiving lane with bicycles in the turning left receiving bicycle lane;

j) the crossing of vehicles in the going straight receiving lane with bicycles in the turning right receiving bicycle lane; and

k) the crossing of vehicles in the going straight receiving lane with bicycles in the turning left receiving bicycle lane.

In one embodiment, the traffic intersection comprises intermediate signaling arrangements configured for signaling vehicles approaching the crossover zone.

In one embodiment, the traffic intersection comprises intermediate bicycle signaling arrangements configured for signaling bicycles approaching the crossover zone.

In one embodiment, the traffic intersection comprises an intermediate bicycle signaling arrangement configured for signaling bicycles in the turning left bicycle lane, the going straight bicycle lane and the turning right bicycle lane approaching the crossover zone.

In one embodiment, the traffic intersection comprises an intermediate signaling arrangement configured for signaling vehicles approaching the crossover zone in the going straight lane and the vehicle turning right lane.

In one embodiment, the crossover zone comprises a first crossover zone distal to the intersection region and a second crossover zone more proximate to the intersection region.

In one embodiment, the first crossover zone is adapted to allow for one or more selected from:

a) bicycles in the turning right bicycle lane to cross paths with vehicles in the turning right lane;

b) bicycles in the going straight bicycle lane to cross paths with vehicles in the turning right lane;

c) bicycles in the turning left bicycle lane to cross paths with vehicles in the turning right lane; and

d) bicycles in the turning left bicycle lane to cross paths with vehicles in the going straight lane.

In one embodiment, the traffic intersection comprises at least one or more intermediate lanes.

In one embodiment, at least one or more of the intermediate lanes extend between the second crossover zone and the crossover zone.

In one embodiment, a turning left intermediate lane extends between the second crossover zone and the crossover zone.

In one embodiment, a turning left intermediate bicycle lane extends between the second crossover zone and the crossover zone.

In one embodiment, the traffic intersection comprises at least one or more intermediate visual signaling arrangements located between the crossover zone and the second crossover zone.

In one embodiment, a vehicle going straight intermediate lane extends from the second crossover zone to an intermediate visual signaling arrangement.

In one embodiment, the intermediate visual signaling arrangements are devices.

In one embodiment, the intermediate visual signaling arrangements traffic lights.

In one embodiment, the intermediate visual signaling arrangements are configured to visually signal one or more selected from the:

a) intermediate going straight lane;

b) intermediate turning left bicycle lane; and

c) intermediate turning left lane.

In one embodiment, the second crossover zone is adapted to allow for one or more selected from:

a) bicycles in the turning right bicycle lane to cross paths with bicycles in the going straight receiving bicycle lane;

b) bicycles in the turning right bicycle lane to cross paths with vehicles in the going straight receiving lane;

c) vehicles in the turning right lane to cross paths with bicycles in the going straight receiving bicycle lane;

d) vehicles in the turning right lane to cross paths with vehicles in the going straight receiving lane;

e) vehicles in the turning right receiving lane to cross paths with bicycles in the turning right receiving bicycle lane;

f) vehicles in the turning right receiving lane to cross paths with bicycles in the turning left receiving bicycle lane;

g) vehicles in the going straight receiving lane to cross paths with bicycles in the turning right receiving bicycle lane; and

h) vehicles in the going straight receiving lane to cross paths with bicycles in the turning left receiving bicycle lane.

In one embodiment, the traffic intersection comprises a pedestrian crossing located distally of the intersection region in a pedestrian crossing region.

In one embodiment, the pedestrian crossing region comprises a U-turn region located adjacent the pedestrian crossing.

In one embodiment, the traffic intersection comprises at least one or more pedestrian crossing vehicle visual signaling devices.

In one embodiment, the pedestrian crossing visual signaling devices are configured for signaling to vehicles in an outer lane that they are free to perform a U-turn on the road, while vehicles in a lane inwardly of the outer lane are stopped.

In one embodiment, the traffic intersection comprises a pedestrian crossing bicycle visual signaling devices.

In one embodiment, the pedestrian crossing bicycle visual signaling devices are configured to stop movement of the bicycles along the bicycle lanes when the vehicle is in the outer lanes are free to perform a U-turn on the road.

For Right-Side Drive Roads

In another aspect, the invention may be said to broadly comprise a traffic intersection located at an intersection of two multilane roads, each road comprising a plurality of traffic lanes spaced one vehicle spacing apart, the traffic intersection comprising:

a) an intersection region wherein the surface area of the intersecting roads overlap; and

b) a proximate region in which each road approaching the intersection includes at least:
i. at least one turning left lane for guiding vehicles to turn right at the intersection onto the intersecting road;
ii. at least one going straight lane for guiding vehicles to move straight through the intersection on the same road;
iii. the turning left lane being configured to split from the other two lanes in the proximate region by crossing through a crossover zone; and
iv. so that vehicles travelling straight through the intersection in an opposite direction along the same road are guided to move between the turning left lane and the going straight lane.

In one embodiment, the proximate region comprises a going straight receiving lane that extends between the turning left lane and the going straight lane, for receiving vehicles moving straight across the intersection region from an opposed side.

In one embodiment, each of the going straight lanes is configured to guide vehicles to move one vehicle spacing to the left in or before the intersection.

In one embodiment, each of the going straight lanes is configured to guide vehicles to the crossover zone, to allow vehicles moving straight through the intersection region to cross the crossover zone while moving at least one vehicle spacing to the right.

In one embodiment, the proximate region further comprises at least one turning right lane for guiding vehicles to turn right at the intersection region onto the intersecting road.

In one embodiment, the going straight lane in the proximate region is also configured as a turning right lane for guiding vehicles to turn right at the intersection region onto the intersecting road.

In one embodiment, the traffic intersection comprises visual signaling devices configured for safely directing vehicles on the roads through the intersection region.

In one embodiment, the visual signaling devices are operable in one of only two modes of operation.

In one embodiment, the visual signaling devices are operable in a go condition and a stop condition.

In one embodiment, the visual signaling device is operable in one of only three modes of operation.

In one embodiment, the visual signaling devices are operable in a go condition, slow condition and a stop condition.

In one embodiment, the visual signaling devices are configured for safely directing pedestrians across at least one of the roads at the proximate region.

In one embodiment, the traffic intersection comprises at least one pedestrian island located between two adjacent lanes in a proximate region.

In one embodiment, at least one pedestrian island is located between two adjacent lanes in each proximate region.

In one embodiment, at least one pedestrian island is located to the left of the turning left lane, when viewed from the direction of the turning left lane.

In one embodiment, the proximate region further comprises at least one receiving lane configured for receiving and guiding one or both selected from

a) vehicles turning right from the intersecting road

b) vehicles turning left from the intersecting road

In one embodiment, the proximate region comprises a plurality of receiving lanes.

In one embodiment, the proximate region comprises at least a first receiving lane configured for receiving and guiding a vehicle turning right from the intersecting road, and at least a second receiving lane configured for receiving and guiding a vehicle turning left from the intersecting road.

In one embodiment, the turning left lane is configured to split from the other lanes in the proximate region by crossing through a crossover zone so that going straight lanes for guiding vehicles moving straight across the intersection from the opposing side are received into a going straight receiving lane that extends between the turning left lane and the going straight lane.

In one embodiment, the traffic intersection comprises an intermediate visual signaling arrangement configured for visually signaling one or more selected from a vehicle and a bicycle in the proximate region approaching the crossover zone.

In one embodiment, the intermediate visual signaling arrangement is one or more selected from road marking and a signaling device.

In one embodiment, the signaling device is a traffic light.

In one embodiment, the traffic intersection comprises a plurality of bicycle lanes.

In one embodiment, the proximate region is configured to present:

a) at least one turning left bicycle lane associated with the turning left lane, the turning left bicycle land being configured for guiding bicycles to turn right at the intersection onto the intersecting road;

b) at least one going straight bicycle lane associated with the going straight lane, the going straight bicycle lane being configured for guiding bicycles to move straight through the intersection on the same road; and

c) the turning left bicycle lane associated with the turning left lane, the turning left bicycle lane being configured to split from the going straight bicycle lane in the proximate region by crossing through a crossover zone, so that vehicles travelling straight through the intersection in an opposite direction along the same road guided to move between the turning left lane and the going straight bicycle lane.

In one embodiment, the proximate region is configured to present a turning right bicycle lane associated with the turning right lane, the turning right bicycle land being configured for guiding bicycles to turn right at the intersection region onto the intersecting road.

In one embodiment, in a region distal to the crossover zone, the traffic intersection comprises traffic intersection comprises at least a pair of bicycle lanes configured for guiding bicycles in opposite directions.

In one embodiment, the bicycle lanes in the region distal to the crossover zone extend centrally along the road.

In one embodiment, the proximate region comprises at least one turning left receiving bicycle lane associated with the first receiving lane, the bicycle turning left receiving lane being configured for receiving and guiding a bicycle turning left from the intersecting road.

In one embodiment, the proximate region comprises at least one turning right receiving bicycle lane associated with the second receiving lane the bicycle turning right receiving lane being configured for receiving and guiding a bicycle turning right from the intersecting road.

In one embodiment, the proximate region comprises at least one going straight receiving bicycle lane associated with the going straight receiving lane, the bicycle going straight receiving lane being configured for receiving and guiding a bicycle going straight over the intersection.

In one embodiment, the traffic intersection comprises bicycle signaling arrangements configured for guiding a bicycle travelling along one or more selected from the turning left bicycle lane, the going straight bicycle lane and the turning right bicycle lane safely through the intersection region.

In one embodiment, the traffic intersection comprises a bicycle signaling arrangement configured for signaling to a bicycle in a bicycle lane approaching the intersection region to guide the bicycle safely through the intersection region.

In one embodiment, the bicycle signaling arrangement is a bicycle signaling device.

In one embodiment, the traffic intersection comprises bicycle storage zones associated with the bicycle lanes in the region distal to the crossover zone.

In one embodiment, the road in the region distal to the crossover zone is configured for providing one or more selected from:

a) parking bays;

b) bicycle hire zones;

c) bus only lanes;

d) bus stop zones; and

e) a taxi rank.

In one embodiment, the traffic intersection comprises bicycle signaling arrangements for visually signaling bicycles in one or more selected from the going straight bicycle lane, the turning left bicycle lane and the turning right bicycle lane to safely guide a bicycle through the intersection region.

In one embodiment, the crossover zone is adapted to allow for one or more selected from the following:

a) the crossing of vehicles in the going straight lane with bicycles in the turning left bicycle lane;

b) the crossing of vehicles in the turning right lane with vehicles in the going straight receiving lane;

c) the crossing of vehicles in the turning right lane with bicycles in the going straight receiving bicycle lane;

d) the crossing of vehicles in the turning right lane with bicycles in the turning left bicycle lane;

e) the crossing of vehicles in the turning right lane with bicycles in the going straight bicycle lane;

f) the crossing of bicycles in the turning right bicycle lane with bicycles in the going straight receiving bicycle lane;

g) the crossing of bicycles in the turning right bicycle lane with vehicles in the going straight receiving lane;

h) the crossing of vehicles in the turning right receiving lane with bicycles in the turning left receiving bicycle lane;

i) the crossing of vehicles in the turning right receiving lane with bicycles in the turning right receiving bicycle lane;

j) the crossing of vehicles in the going straight receiving lane with bicycles in the turning left receiving bicycle lane; and

k) the crossing of vehicles in the going straight receiving lane with bicycles in the turning right receiving bicycle lane.

In one embodiment, the traffic intersection comprises intermediate signaling arrangements configured for signaling vehicles approaching the crossover zone.

In one embodiment, the traffic intersection comprises intermediate bicycle signaling arrangements configured for signaling bicycles approaching the crossover zone.

In one embodiment, the traffic intersection comprises an intermediate bicycle signaling arrangement configured for signaling bicycles in the turning right bicycle lane, the going straight bicycle lane and the turning left bicycle lane approaching the crossover zone.

In one embodiment, the traffic intersection comprises an intermediate signaling arrangement configured for signaling vehicles approaching the crossover zone in the going straight lane and the vehicle turning left lane.

In one embodiment, the crossover zone comprises a first crossover zone distal to the intersection region and a second crossover zone more proximate to the intersection region.

In one embodiment, the first crossover zone is adapted to allow for one or more selected from

a) bicycles in the turning left bicycle lane to cross paths with vehicles in the turning lane.

b) bicycles in the going straight bicycle lane to cross paths with vehicles in the turning left lane;

c) bicycles in the turning right bicycle lane to cross paths with vehicles in the turning left lane; and

d) bicycles in the turning right bicycle lane to cross paths with vehicles in the going straight lane.

In one embodiment, the traffic intersection comprises at least one or more intermediate lanes.

In one embodiment, at least one or more of the intermediate lanes extend between the second crossover zone and the crossover zone.

In one embodiment, a turning right intermediate lane extends between the second crossover zone and the crossover zone.

In one embodiment, a turning right intermediate bicycle lane extends between the second crossover zone and the crossover zone.

In one embodiment, the traffic intersection comprises at least one or more intermediate visual signaling arrangements located between the crossover zone and the second crossover zone.

In one embodiment, a vehicle going straight intermediate lane extends from the second crossover zone to an intermediate visual signaling arrangement.

In one embodiment, the intermediate visual signaling arrangements are devices.

In one embodiment, the intermediate visual signaling arrangements traffic lights.

In one embodiment, the intermediate visual signaling arrangements are configured to visually signal one or more selected from the:

a) intermediate going straight lane;

b) intermediate turning right bicycle lane; and

c) intermediate turning right lane.

In one embodiment, the second crossover zone is adapted to allow for one or more selected from:

a) bicycles in the turning left bicycle lane to cross paths with bicycles in the going straight receiving bicycle lane;

b) bicycles in the turning left bicycle lane to cross paths with vehicles in the going straight receiving lane;

c) vehicles in the turning left lane to cross paths with bicycles in the going straight receiving bicycle lane;

d) vehicles in the turning left lane to cross paths with vehicles in the going straight receiving lane;

e) vehicles in the turning left receiving lane to cross paths with bicycles in the turning left receiving bicycle lane;

f) vehicles in the turning left receiving lane to cross paths with bicycles in the turning right receiving bicycle lane;

g) vehicles in the going straight receiving lane to cross paths with bicycles in the turning left receiving bicycle lane; and

h) vehicles in the going straight receiving lane to cross paths with bicycles in the turning right receiving bicycle lane.

For Left Side Drive Roads

In another aspect, the invention may be said to broadly comprise a guidance system for guiding traffic through an intersection of two multilane roads, at least one multilane road being configured for guiding traffic moving in opposing directions, each road comprising a plurality of traffic lanes spaced one vehicle spacing apart, the system comprising:

a) a turning right visual signaling device for signaling to at least one turning right lane for guiding vehicles to turn left at the intersection onto the intersecting road;

b) a going straight visual signaling device for signaling to at least one going straight lane for guiding vehicles to move straight through the intersection on the same road;

c) the turning right visual signaling device being distanced from the nearest going straight visual signaling device by at least two vehicle spacings; and

d) the guidance system being configured for guiding vehicles across the intersection in one of two configurations.

In one embodiment, the guidance system is configured for guiding vehicles across the intersection in one of two configurations.

In one embodiment, the guidance system is configured for guiding vehicles across the intersection in one of three conditions.

In one embodiment, the guidance system is configurable in a stop condition in which vehicles are directed to come to a halt, a slow condition in which vehicles are directed to slow down in preparation for coming to a halt and a go condition in which vehicles are directed to move through the intersection.

In one embodiment, the system further comprises a turning left visual signaling device for signaling to at least one turning left lane for guiding vehicles to turn left at the intersection onto the intersecting road.

In one embodiment, the going straight lane in the proximate region is also configured as a turning left lane for guiding vehicles to turn left at the intersection region onto the intersecting road.

In one embodiment, at least one or more of the visual signaling devices are reconfigurable between a go condition and a stop condition.

In one embodiment, the guidance system comprises a controller controlling operation of one or more of the signaling devices.

In one embodiment, the controller comprises a processor configured for receiving instructions from digital storage media.

In one embodiment, the controller comprises digital storage media for storing digital instructions.

In one embodiment, the visual signaling devices are configurable in one of two conditions corresponding to the conditions of the guidance system.

In one embodiment, the visual signaling devices are configurable in one of three conditions corresponding to the conditions of the guidance system.

In one embodiment, the visual signaling devices are configurable between a stop condition, a go condition and a slow condition.

In one embodiment, the controller is configured for controlling the visual signaling devices to switch between their stop condition, go condition and slow condition.

In one embodiment, the guidance system comprises bicycle visual signaling devices for signaling to bicycles in bicycle lanes associated with the vehicle lanes.

In one embodiment, the guidance system comprises a turning left bicycle visual signaling device for signaling to at least one turning left bicycle lane for guiding bicycles to turn left at the intersection onto the intersecting road.

In one embodiment, the guidance system comprises a turning right bicycle visual signaling device for signaling to at least one turning right bicycle lane for guiding bicycles to turn right at the intersection onto the intersecting road.

In one embodiment, the guidance system comprises a going straight bicycle visual signaling device for signaling to at least one going straight bicycle lane for guiding bicycles to move straight across the intersection onto the intersecting road.

In one embodiment, the guidance system comprises intermediate visual signaling devices configured for signaling to one or more selected from bicycles and vehicles approaching the crossover zone.

In one embodiment, the intermediate visual signaling devices comprise bicycle visual signaling devices configured for visually signaling to bicycles in one or more selected from:

a) a turning left bicycle lane approaching the crossover zone;

b) a turning right bicycle lane approaching the crossover zone;

c) a going straight bicycle lane approaching the crossover zone.

In one embodiment, the intermediate visual signaling devices are configured for visually signaling to vehicles on one or more selected from:

a) a turning right lane for guiding vehicles approaching the crossover zone and wanting to turn right at the intersection; and

b) a going straight lane for guiding vehicles approaching the crossover zone that wish to move straight through the intersection.

In one embodiment, the crossover zone comprises a first crossover zone distal to the intersection and a second crossover zone more proximal to the intersection, the first crossover zone and the second crossover zone being separated by intermediate guiding lanes, and the guidance system comprises intermediate visual signaling devices for signaling to one or more selected from vehicles and bicycles in the intermediate guiding lanes.

In one embodiment, the intermediate visual signaling devices are configured for visually signaling to bicycles on a turning right intermediate bicycle lane for guiding bicycles approaching the second crossover zone.

In one embodiment, the intermediate visual signaling devices are configured for visually signaling to vehicles on one or more selected from:

a) a turning right intermediate lane for guiding vehicles approaching the second crossover zone and intending to turn right at the intersection; and

b) a going straight intermediate lane for guiding vehicles crossing the first crossover zone and intending to move straight over the intersection.

For Right-Side Drive Roads

In another aspect, the invention may be said to broadly comprise a guidance system for guiding traffic through an intersection of two multilane roads, at least one multilane road being configured for guiding traffic moving in opposing directions, each road comprising a plurality of traffic lanes spaced one vehicle spacing apart, the system comprising

a) a turning left visual signaling device for signaling to at least one turning left lane for guiding vehicles to turn right at the intersection onto the intersecting road;

b) a going straight visual signaling device for signaling to at least one going straight lane for guiding vehicles to move straight through the intersection on the same road;

c) the turning left visual signaling device being distanced from the nearest going straight visual signaling device by at least two vehicle spacings.

In one embodiment, the guidance system is configured for guiding vehicles across the intersection in one of two configurations.

In one embodiment, the guidance system is configured for guiding vehicles across the intersection in one of three conditions.

In one embodiment, the guidance system is configurable in a stop condition in which vehicles are directed to come to a halt, a slow condition in which vehicles are directed to slow down in preparation for coming to a halt and a go condition in which vehicles are directed to move through the intersection.

In one embodiment, the system further comprises a turning right visual signaling device for signaling to at least one turning right lane for guiding vehicles to turn right at the intersection onto the intersecting road.

In one embodiment, the going straight lane in the proximate region is also configured as a turning right lane for guiding vehicles to turn right at the intersection region onto the intersecting road.

In one embodiment, at least one or more of the visual signaling devices are reconfigurable between a go condition and a stop condition.

In one embodiment, the guidance system comprises a controller controlling operation of one or more of the signaling devices.

In one embodiment, the controller comprises a processor configured for receiving instructions from digital storage media.

In one embodiment, the controller comprises digital storage media for storing digital instructions.

In one embodiment, the visual signaling devices are configurable in one of two conditions corresponding to the conditions of the guidance system.

In one embodiment, the visual signaling devices are configurable in one of three conditions corresponding to the conditions of the guidance system.

In one embodiment, the visual signaling devices are configurable between a stop condition, a go condition and a slow condition.

In one embodiment, the controller is configured for controlling the visual signaling devices to switch between their stop condition, go condition and slow condition.

In one embodiment, the guidance system comprises bicycle visual signaling devices for signaling to bicycles in bicycle lanes associated with the vehicle lanes.

In one embodiment, the guidance system comprises a turning right bicycle visual signaling device for signaling to at least one turning right bicycle lane for guiding bicycles to turn right at the intersection onto the intersecting road.

In one embodiment, the guidance system comprises a turning left bicycle visual signaling device for signaling to at least one turning left bicycle lane for guiding bicycles to turn left at the intersection onto the intersecting road.

In one embodiment, the guidance system comprises a going straight bicycle visual signaling device for signaling to at least one going straight bicycle lane for guiding bicycles to move straight across the intersection onto the intersecting road.

In one embodiment, the guidance system comprises intermediate visual signaling devices configured for signaling to one or more selected from bicycles and vehicles approaching the crossover zone.

In one embodiment, the intermediate visual signaling devices comprise bicycle visual signaling devices configured for visually signaling to bicycles in one or more selected from:

a) a turning right bicycle lane approaching the crossover zone;

b) a turning left bicycle lane approaching the crossover zone;

c) a going straight bicycle lane approaching the crossover zone.

In one embodiment, the intermediate visual signaling devices are configured for visually signaling to vehicles on one or more selected from:

a) a turning left lane for guiding vehicles approaching the crossover zone and wanting to turn left at the intersection; and

b) a going straight lane for guiding vehicles approaching the crossover zone that wish to move straight through the intersection.

In one embodiment, the crossover zone comprises a first crossover zone distal to the intersection and a second crossover zone more proximal to the intersection, the first crossover zone and the second crossover zone being separated by intermediate guiding lanes, and the guidance system comprises intermediate visual signaling devices for signaling to one or more selected from vehicles and bicycles in the intermediate guiding lanes.

In one embodiment, the intermediate visual signaling devices are configured for visually signaling to bicycles on a turning left intermediate bicycle lane for guiding bicycles approaching the second crossover zone.

In one embodiment, the intermediate visual signaling devices are configured for visually signaling to vehicles on one or more selected from:

a) a turning left intermediate lane for guiding vehicles approaching the second crossover zone and intending to turn left at the intersection; and

b) a going straight intermediate lane for guiding vehicles crossing the first crossover zone and intending to move straight over the intersection.

In one embodiment, the intersection is a traffic intersection as described above.

In another aspect, the invention may be said to broadly comprise a traffic intersection located at an intersection of two multilane roads, at least one multilane road being configured for guiding traffic moving in opposing directions, and each road comprising a plurality of traffic lanes spaced one vehicle spacing apart, the traffic intersection comprising:

a) lane markings configured to guide vehicles from at least one road onto an intersecting road across the flow of oncoming traffic; and

b) a guidance system configured for safely guiding traffic via the lane markings using one of only two configurations.

Preferably, in one embodiment, the guidance system is configured for guiding traffic via the lane markings using one of only three configurations.

In another aspect, the invention may be said to broadly comprise a traffic guidance system for deployment at a traffic intersection located at an intersection of two multilane roads, at least one multilane road being configured for guiding traffic moving in opposing directions, each road comprising a plurality of traffic lanes spaced one vehicle spacing apart, the traffic guidance system comprising:

a) at least one or more visual signaling devices configured for displaying guidance signals to vehicles on both intersecting roads, including displaying guidance signals to vehicles turning across the flow of oncoming traffic; and

b) a control system configured for controlling operation of the visual signaling devices in one of two modes to thereby guide vehicles to move safely across the intersection.

In one embodiment, the two modes are

a) a go condition in which vehicles in a particular lane are directed to move through the intersection; and

b) a stop condition in which vehicles are directed to come to a halt.

In one embodiment, the control system is configured for controlling operation of the visual signaling devices in one of three modes.

In one embodiment, the three modes are:

a) a go condition in which vehicles in a particular lane are directed to move through the intersection;

b) a stop condition in which vehicles are directed to come to a halt; and

c) a slow condition in which vehicles approaching the intersection are directed to slow down in preparation for coming to a halt.

In another aspect, the invention may be said to broadly comprise a pedestrian crossing for guiding pedestrians across a road at a traffic intersection, the pedestrian crossing comprising:

a) markings designating a pedestrian waiting zone;

b) markings designating a first pedestrian crossing zone;

c) markings designating a second pedestrian crossing zone; and

d) wherein the markings designating the pedestrian waiting zone is located at least partially on a lane for receiving vehicles turning right from an intersecting road.

In one embodiment, the pedestrian waiting zone is located at least partially on a lane for receiving vehicles turning left from an intersecting road.

In another aspect, the invention may be said to broadly comprise a pedestrian crossing guidance system for guiding pedestrians across a road of an intersection of two multilane roads, the road being configured for guiding traffic moving in opposing directions, the pedestrian crossing guidance system comprising:

a) a first pedestrian visual signaling device configured for displaying a visual signal to a pedestrian a pedestrian waiting zone located adjacent a first side of the road and at least partially on a lane for receiving vehicles turning right from an intersecting road; to an opposed second side of the road; and

b) a second pedestrian visual signaling device for displaying a visual signal to a pedestrian on the second side to move from the second side of the road to the first side of the road.

In one embodiment, the first pedestrian visual signaling device is configured for displaying a visual signal to a pedestrian to move from the pedestrian waiting zone two in opposed second side of the road via a first crossing zone.

In one embodiment, the second pedestrian visual signaling devices is configured for displaying a visual signal to a pedestrian to move from the second side of the road to the first side of the road through a second crossing zone.

In one embodiment, the pedestrian crossing guidance system comprises a controller for controlling operation of the first visual signaling device and the second visual signaling device.

In one embodiment, the pedestrian visual signaling devices are controllable by the controller to guide pedestrians in synchronization with the visual signaling devices of the traffic guidance system described above.

In one embodiment, the first pedestrian visual signaling device is configured to be controlled by a controller to cause pedestrians to move across the first crossing zone towards the second side of the road when vehicles in the going straight lane, the going straight receiving lane and the turning right lane are stationary.

In one embodiment, the first pedestrian visual signaling device is configured to be controlled by a controller to cause pedestrians to move across the first crossing zone towards the second side of the road when before the vehicles to be received into the turning left receiving lane and the turning right receiving lane from the intersecting road start moving.

In one embodiment, the second pedestrian visual signaling device is configured to be controlled by a controller to cause pedestrians to move across the second crossing zone when vehicles in the going straight lane, the going straight receiving lane and the turning right lane have been brought to a halt by the visual signaling devices.

In one embodiment, the second pedestrian visual signaling devices configured to provide a visual signal to pedestrians in time to first allow for vehicles turning into the turning left receiving lane and/or the turning right receiving lane to be received first.

In an alternative embodiment, the second pedestrian visual signaling device is configured to provide a visual signal to pedestrians to allow them to cross the second crossing zone before vehicles are received into the turning left receiving lane and/or the turning right receiving lane.

In one embodiment, each of the visual signaling devices of operable in one of two modes.

In one embodiment, the two modes are a go condition and a stop condition.

In one embodiment, the first visual signaling device is configured to move into a go condition when

In one embodiment, the intersection is a traffic intersection as described above.

In one embodiment, the pedestrian crossing guidance system comprises a controller.

In one embodiment, the controller is configured to also guide a traffic guidance system for guiding vehicle movement across a traffic intersection.

In one embodiment, the traffic intersection is a traffic intersection as described above.

In one embodiment, the pedestrian crossing guidance system is configured for guiding pedestrians across in synchronised operation with the traffic guidance system.

For Right-Side Drive

In another aspect, the invention may be said to broadly comprise a traffic signaling arrangement comprising:

a) a first set of visual signaling devices configured for displaying a visual signal in a first direction to vehicles approaching an intersection, the visual signals including:
i. a left turn signal for guiding alignment of vehicles wishing to turn right at the intersection; and
ii. a going straight signal for guiding alignment of vehicles wishing to move straight through the intersection;

b) a second set of visual signaling devices configured for displaying a visual signal in a second direction opposed to the first direction to vehicles moving through the intersection, the visual signals including:
i. a receiving going straight signal for guiding alignment of vehicles having moved to the intersection to continue moving straight on the same road; and
ii. a receiving left turn signal for guiding alignment of vehicles moving through the intersection to turn right onto an intersecting road.

For Left Side Drive

In another aspect, the invention may be said to broadly comprise a traffic signaling arrangement comprising:

a) a first set of visual signaling devices configured for displaying a visual signal in a first direction to vehicles approaching an intersection, the visual signals including:
i. a right turn signal for guiding alignment of vehicles wishing to turn right at the intersection; and
ii. a receiving going straight signal for guiding alignment of vehicles wishing to move straight through the intersection;

b) a second set of visual signaling devices configured for displaying a visual signal in a second direction opposed to the first direction to vehicles moving through the intersection, the visual signals including:
i. a going straight signal for guiding alignment of vehicles having moved to the intersection to continue moving straight on the same road; and
ii. a receiving right turn signal for guiding alignment of vehicles moving through the intersection to turn right onto an intersecting road.

In one embodiment, the first set of visual signaling devices and the second set of visual signaling devices are configured for operation in one of two modes.

In one embodiment, the first set of visual signaling devices and the second set of visual signaling devices configured for operation in one of three modes.

In one embodiment, the two modes are a stop condition and a go condition.

In one embodiment, in the three modes are a stop condition, a go condition, and a slow condition.

In one embodiment, the first set of visual signaling devices and the second set of visual signaling devices controlled by a control system.

In one embodiment, the control system comprises a controller.

In one embodiment, the first set of visual signaling devices is further configured to signal a left turn signal for guiding alignment of vehicles wishing to turn left at an intersection.

In one embodiment, the second set of visual signaling devices is further configured for displaying a receiving left turn signal for guiding alignment of vehicles moving through the intersection to turn left onto an intersecting road.

In another aspect, the invention may be said to broadly comprise a directional indicator arrangement for a traffic intersection of two multilane roads, the directional indicator arrangement comprising:

a) at least four marking protocols, each marking protocol being indicative of a range of compass directions.

In one embodiment, the marking protocols comprise pre-allocated coloring protocols.

In one embodiment, marking protocol comprises allocating a different color to four ranges of compass directions.

In one embodiment, the ranges of compass directions extend to 45° of each of the main compass directions North, East, South and West.

In another aspect, the invention may be said to broadly comprise a method of marking a traffic intersection of at least two multilane roads with a directional indicator arrangement, the method comprising:

a) marking each road adjacent the traffic intersection in a marking protocol, wherein the marking protocol corresponds to a range of compass directions.

In one embodiment, the marking protocols comprise pre-allocated coloring protocols.

In one embodiment, marking protocol comprises allocating a different color to four ranges of compass directions.

In one embodiment, the ranges of compass directions extend to 45° of each of the main compass directions North, East, South and West.

In another aspect, the invention may be said to broadly comprise a method of determining a marking protocol for a traffic intersection comprising the steps of:

a) allocating a marking protocol to a range of compass directions;

b) allocating a first determination lines at a traffic intersection between two consistent features of a traffic intersection;

c) determining the direction of the first determination line; and

d) marking the traffic intersection according to the marking protocol corresponding to the range of compass directions that the direction of the first determination line falls within.

In one embodiment, the method further comprises the step of allocating a second determination line that the traffic intersection between two consistent features of a traffic intersection.

In one embodiment, in the event where the first determination line extends in a direction corresponding to an edge of the allocated range of compass directions, the method further comprises the step of marking the traffic intersection according to the marking protocol corresponding to the range of compass directions that the direction of the second determination line falls within.

In another aspect, the invention may be said to broadly comprise a traffic intersection configured to display directional information.

In one embodiment, the traffic intersection is configured to display directional information as per the directional indicator arrangement described above.

It should be noted that the web server, client computing device and the computer readable storage medium provide the same or similar advantages as the advantages provided by the corresponding computer implemented method, some of which are described herein. Additionally the web server and/or client computing device provides the advantage of deployment across a computer network, such as the Internet, providing distribution, access and economy of scale advantages. Furthermore, the computer readable storage medium provides further advantages, such allowing the deployment of computer instructions for installation and execution by one or more computing devices.

For Left Hand Side Roads

According to a first aspect of the present invention, the invention may be said to broadly comprise a traffic intersection located at an intersection of two multilane roads, each road comprising a plurality of traffic lanes spaced one vehicle spacing apart, the traffic intersection comprising:

a) an intersection region wherein the surface area of the intersecting roads overlap; and

b) a proximate region in which each road approaching the intersection includes at least:
i. at least one turning right lane for guiding vehicles to turn left at the intersection onto the intersecting road;
ii. at least one going straight lane for guiding vehicles to move straight through the intersection on the same road; and
iii. the turning right lane being configured to extend from the going straight lane at a distance from the going straight lane in the proximate region by crossing through a crossover zone, so that vehicles travelling straight through the intersection in an opposite direction along the same road are guided to move between the turning right lane and the going straight lane.

For Right Hand Side Roads

According to a first aspect of the present invention, the invention may be said to broadly comprise a traffic intersection located at an intersection of two multilane roads, each road comprising a plurality of traffic lanes spaced one vehicle spacing apart, the traffic intersection comprising:

a) an intersection region wherein the surface area of the intersecting roads overlap; and

b) a proximate region in which each road approaching the intersection includes at least:
i. at least one turning left lane for guiding vehicles to turn left at the intersection onto the intersecting road;
ii. at least one going straight lane for guiding vehicles to move straight through the intersection on the same road; and
iii. the turning left lane being configured to extend from the going straight lane at a distance from the going straight lane in the proximate region by crossing through a crossover zone, so that vehicles travelling straight through the intersection in an opposite direction along the same road are guided to move between the turning left lane and the going straight lane.

In another aspect invention may be said to comprise a guidance system for guiding traffic through a traffic intersection, with each road in the traffic intersection comprising a plurality of traffic lanes spaced one vehicle spacing apart, the system comprising:

a) a turning left visual signaling device for signaling to at least one turning left lane for guiding vehicles to turn right at the intersection onto the intersecting road;

b) a going straight visual signaling device for signaling to at least one going straight lane for guiding vehicles to move straight through the intersection on the same road;

c) the turning left visual signaling device being distanced from the nearest going straight visual signaling device by at least two vehicle spacings; and

d) a controller configured for controlling operation of the signaling devices.

Other aspects of the invention are also disclosed.

Although the systems and methods are illustrated and described herein as embodied in a traffic intersection, a system for directing traffic and a method therefor, it is, nevertheless, not intended to be limited to the details shown because various modifications and structural changes may be made therein without departing from the spirit of the invention and within the scope and range of equivalents of the claims. Additionally, well-known elements of exemplary embodiments will not be described in detail or will be omitted so as not to obscure the relevant details of the systems and methods.

Additional advantages and other features characteristic of the systems and methods will be set forth in the detailed description that follows and may be apparent from the detailed description or may be learned by practice of exemplary embodiments. Still other advantages of the systems and methods may be realized by any of the instrumentalities, methods, or combinations particularly pointed out in the claims.

Other features that are considered as characteristic for the systems and methodsare set forth in the appended claims. As required, detailed embodiments of the systems and methodsare disclosed herein; however, it is to be understood that the disclosed embodiments are merely exemplary of the systems and methods, which can be embodied in various forms. Therefore, specific structural and functional details disclosed herein are not to be interpreted as limiting, but merely as a basis for the claims and as a representative basis for teaching one of ordinary skill in the art to variously employ the systems and methods in virtually any appropriately detailed structure. Further, the terms and phrases used herein are not intended to be limiting; but rather, to provide an understandable description of the systems and methods. While the specification concludes with claims defining the systems and methods of the invention that are regarded as novel, it is believed that the systems and methods will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the systems and methods. Advantages of embodiments of the systems and methods will be apparent from the following detailed description of the exemplary embodiments thereof, which description should be considered in conjunction with the accompanying drawings in which:

FIG. 1 shows a schematic view of an exemplary embodiment of a traffic intersection of two roads, with vehicles moving in both directions on each road;

FIG. 2 shows a schematic view of a second exemplary embodiment of a traffic intersection of two roads, with vehicles moving in both directions on each road;

FIG. 3 shows a schematic view of a third exemplary embodiment of a traffic intersection of two roads, with vehicles moving in both directions on each road;

FIG. 4 shows a schematic view of a fourth exemplary embodiment of a traffic intersection of two roads, with vehicles moving in both directions on each road;

FIG. 5 shows a schematic view of a first exemplary mode of operation of traffic intersection of two roads, with vehicles moving in only one direction on one road, and vehicles moving in both directions on the other;

FIG. 6 shows a schematic view of a second exemplary mode of operation of the traffic intersection of FIG. 5;

FIG. 7 shows a perspective view of a proximate region of a traffic intersection viewed outwardly from the intersection region;

FIG. 8 shows a close-up perspective view of FIG. 7;

FIG. 9 shows a perspective view of an exemplary embodiment of a traffic signaling arrangement, and pedestrian crossing;

FIG. 10 shows a schematic view of an exemplary embodiment of a pedestrian crossing guidance system and a traffic guidance system;

FIG. 11a shows a schematic diagram illustrating an exemplary embodiment of a directional indicator arrangement, and a traffic intersection marked to show one of the range directions;

FIG. 11b shows a schematic diagram illustrating an exemplary embodiment of a directional indicator arrangement, and a traffic intersection marked to show another one of the range directions;

FIG. 11c shows a schematic diagram illustrating an exemplary embodiment of a directional indicator arrangement, and a traffic intersection marked to show another one of the range directions;

FIG. 11d shows a schematic diagram illustrating an exemplary embodiment of a directional indicator arrangement, and a traffic intersection marked to show another one of the range directions;

FIG. 12 shows a schematic diagram illustrating an exemplary embodiment of a directional indicator arrangement, and a traffic intersection marked to show all of the range directions;

FIG. 13 shows a perspective view of a proximate region of an exemplary embodiment of a traffic intersection;

FIG. 14 shows a schematic diagram illustrating an exemplary embodiment of a traffic intersection with two determination lines;

FIG. 15 shows a schematic diagram illustrating an exemplary embodiment of a directional indicator arrangement, and a traffic intersection marked to show all of the range directions;

FIG. 16 shows a schematic diagram illustrating a second exemplary embodiment of a directional indicator arrangement, and a traffic intersection marked with the directional indicator arrangement;

FIG. 17 shows a schematic diagram illustrating a third exemplary embodiment of a directional indicator arrangement, and a traffic intersection marked with the directional indicator arrangement;

FIG. 18a shows a schematic diagram illustrating an exemplary embodiment of a traffic intersection operational in a first mode of operation;

FIG. 18b shows a schematic diagram illustrating an exemplary embodiment of a traffic intersection operational in a second mode of operation;

FIG. 19 shows a schematic diagram illustrating an exemplary embodiment of a traffic intersection including bicycle lanes;

FIG. 20 shows a schematic diagram of a portion of an exemplary embodiment of a traffic intersection with bicycle lanes, showing a single crossover zone and a pedestrian crossing region;

FIG. 21 shows a schematic diagram of an exemplary embodiment of a traffic intersection with bicycle lanes, showing a single crossover zone;

FIG. 22 shows a schematic diagram of a portion of an exemplary embodiment of a traffic intersection with bicycle lanes, showing a single crossover zone and a pedestrian crossing region;

FIG. 23 shows a portion of an exemplary embodiment of a traffic intersection with bicycle lanes, showing a single crossover zone and proximate region;

FIG. 24 shows a schematic diagram of a portion of an exemplary embodiment of a traffic intersection with bicycle lanes, showing a first crossover zone, second crossover zone and a pedestrian crossing region;

FIG. 25 shows a schematic diagram of a portion of an exemplary embodiment of a traffic intersection with bicycle lanes, showing a first crossover zone and second crossover zone;

FIG. 26 shows a schematic diagram of a portion of an exemplary embodiment of a traffic intersection including bicycle lanes, showing the intersection region;

FIG. 27 shows a schematic diagram of the proximate region of an exemplary embodiment of a traffic intersection including bicycle lanes;

FIG. 28 shows a schematic diagram of the proximate region of an exemplary embodiment of a traffic intersection including bicycle lanes;

FIG. 29 shows a schematic diagram of the proximate region of an exemplary embodiment of a traffic intersection including bicycle lanes; and

FIG. 30 shows a schematic diagram of the proximate region of an exemplary embodiment of a traffic intersection including bicycle lanes.

### DETAILED DESCRIPTION OF THE INVENTION

As required, detailed embodiments of the systems and methods are disclosed herein; however, it is to be understood that the disclosed embodiments are merely exemplary of the systems and methods, which can be embodied in various forms. Therefore, specific structural and functional details disclosed herein are not to be interpreted as limiting, but merely as a basis for the claims and as a representative basis for teaching one skilled in the art to variously employ the systems and methods in virtually any appropriately detailed structure. Further, the terms and phrases used herein are not intended to be limiting; but rather, to provide an understandable description of the systems and methods. While the specification concludes with claims defining the features of the systems and methods that are regarded as novel, it is believed that the systems and methods will be better understood from a consideration of the following description in conjunction with the drawing figures, in which like reference numerals are carried forward.

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Alternate embodiments may be devised without departing from the spirit or the scope of the invention. Additionally, well-known elements of exemplary embodiments of the systems and methods will not be described in detail or will be omitted so as not to obscure the relevant details of the systems and methods.

Before the systems and methods are disclosed and described, it is to be understood that the terminology used herein is for the purpose of describing particular embodiments only and is not intended to be limiting. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element. The terms “including” and/or “having,” as used herein, are defined as comprising (i.e., open language). The terms “a” or “an”, as used herein, are defined as one or more than one. The term “plurality,” as used herein, is defined as two or more than two. The term “another,” as used herein, is defined as at least a second or more. The description may use the terms “embodiment” or “embodiments,” which may each refer to one or more of the same or different embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact (e.g., directly coupled). However, “coupled” may also mean that two or more elements are not in direct contact with each other, but yet still cooperate or interact with each other (e.g., indirectly coupled).

For the purposes of the description, a phrase in the form “A/B” or in the form “A and/or B” or in the form “at least one of A and B” means (A), (B), or (A and B), where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables, for example, a phrase in the form “at least one of A, B, and C” means (A), (B), (C), (A and B), (A and C), (B and C), or (A, B and C).

Relational terms such as first and second, top and bottom, and the like may be used solely to distinguish one entity or action from another entity or action without necessarily requiring or implying any actual such relationship or order between such entities or actions. The description may use perspective-based descriptions such as up/down, back/front, and top/bottom. Such descriptions are merely used to facilitate the discussion and are not intended to restrict the application of disclosed embodiments. Various operations may be described as multiple discrete operations in tum, in a manner that may be helpful in understanding embodiments; however, the order of description should not be construed to imply that these operations are order dependent.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

It will be appreciated that embodiments of the systems and methods described herein may be comprised of one or more conventional processors and unique stored program instructions that control the one or more processors to implement, in conjunction with certain non-processor circuits and other elements, some, most, or all of the functions of the devices and methods described herein. The non-processor circuits may include, but are not limited to, signal drivers, clock circuits, power source circuits, and user input and output elements. Alternatively, some or all functions could be implemented by a state machine that has no stored program instructions, or in one or more application specific integrated circuits (ASICs) or field-programmable gate arrays (FPGA), in which each function or some combinations of certain of the functions are implemented as custom logic. Of course, a combination of these approaches could also be used. Thus, methods and means for these functions have been described herein.

The terms “program,” “software,” “software application,” and the like as used herein, are defined as a sequence of instructions designed for execution on a computer system or programmable device. A “program,” “software,” “application,” “computer program,” or “software application” may include a subroutine, a function, a procedure, an object method, an object implementation, an executable application, an applet, a servlet, a source code, an object code, any computer language logic, a shared library/dynamic load library and/or other sequence of instructions designed for execution on a computer system.

Herein various embodiments of the systems and methods are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

It should be noted in the following description that like or the same reference numerals in different embodiments denote the same or similar features.

It should further be noted that the present invention relates to traffic intersections and traffic guidance systems. However, various countries may have different road laws relating to the sides of the road that vehicles are allowed to drive on.

Traffic Intersection

For the purposes of explanation of the present invention, the intersections and traffic guidance systems of the present invention will be described with reference to road laws requiring vehicles to drive on the left hand side of the road. However, it will be appreciated that the invention may be carried out as effectively on intersections and traffic guidance systems operational in countries where vehicles drive on the right-hand side of the road by interchanging any reference to the word right with the word left, and any reference to the word left with the word right.

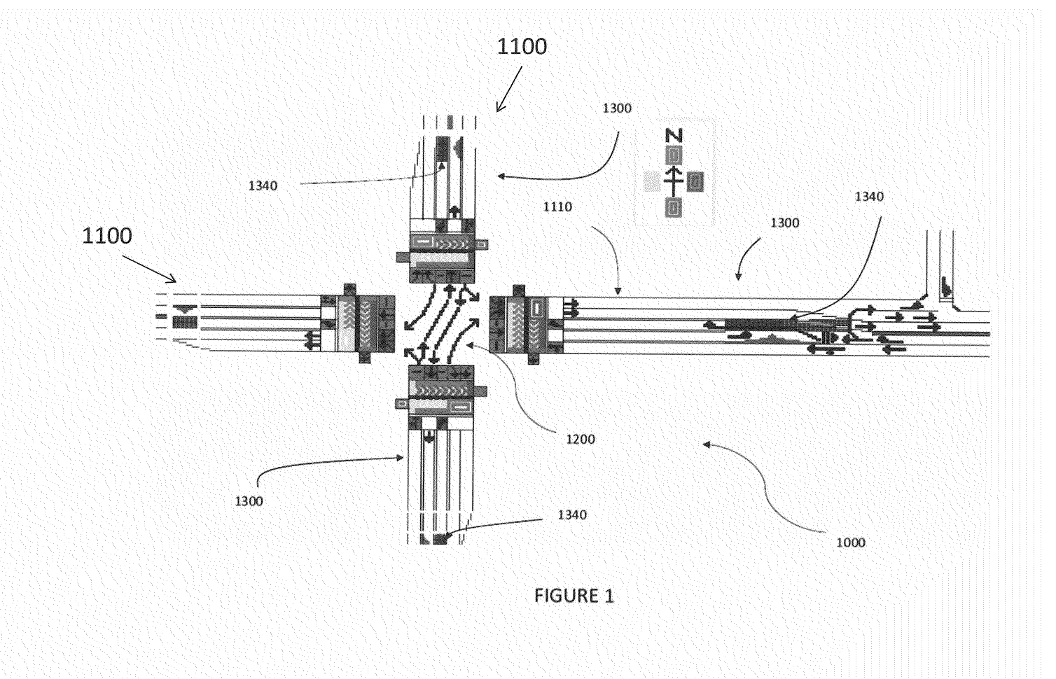

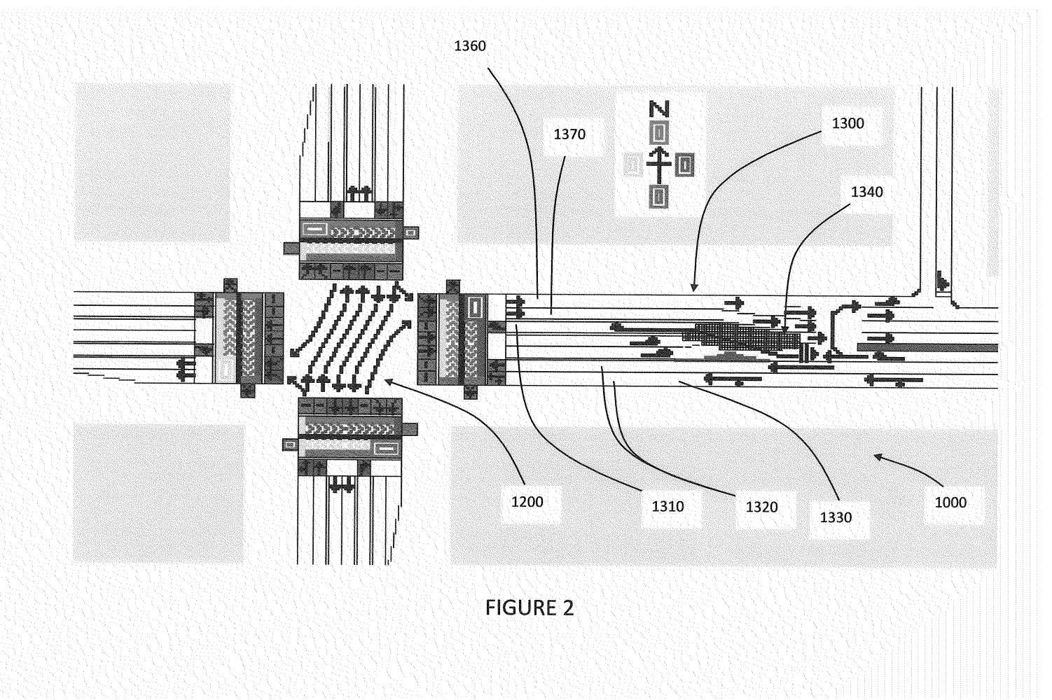

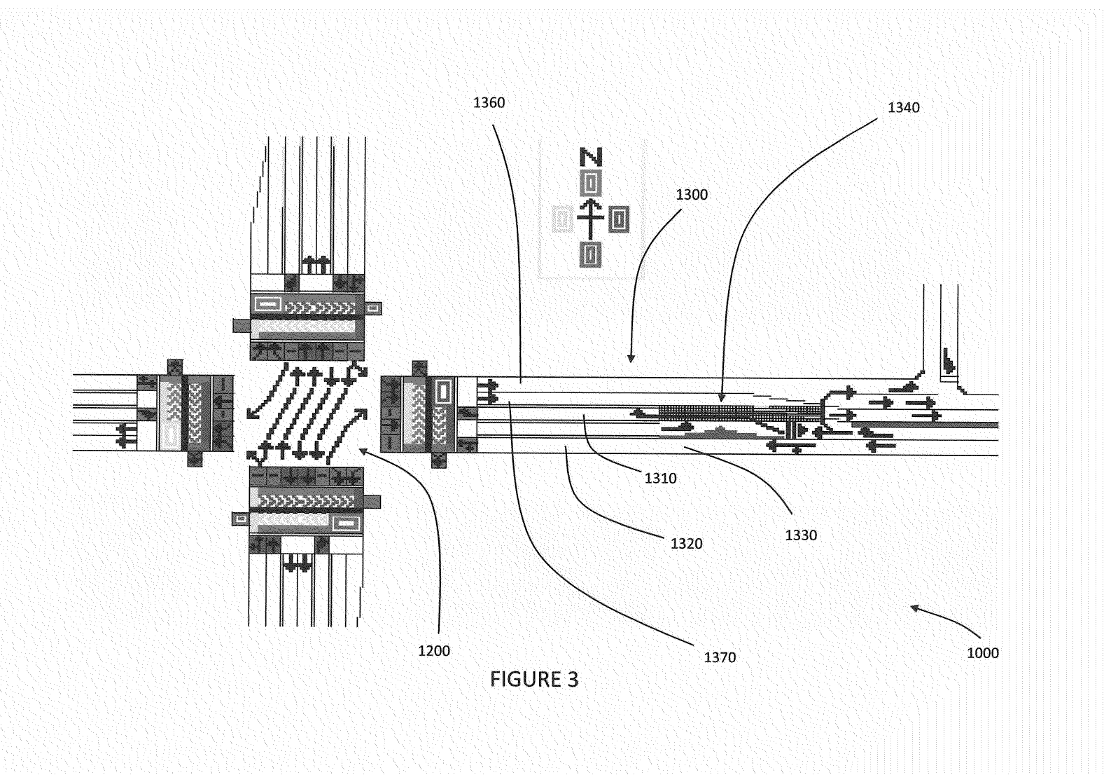

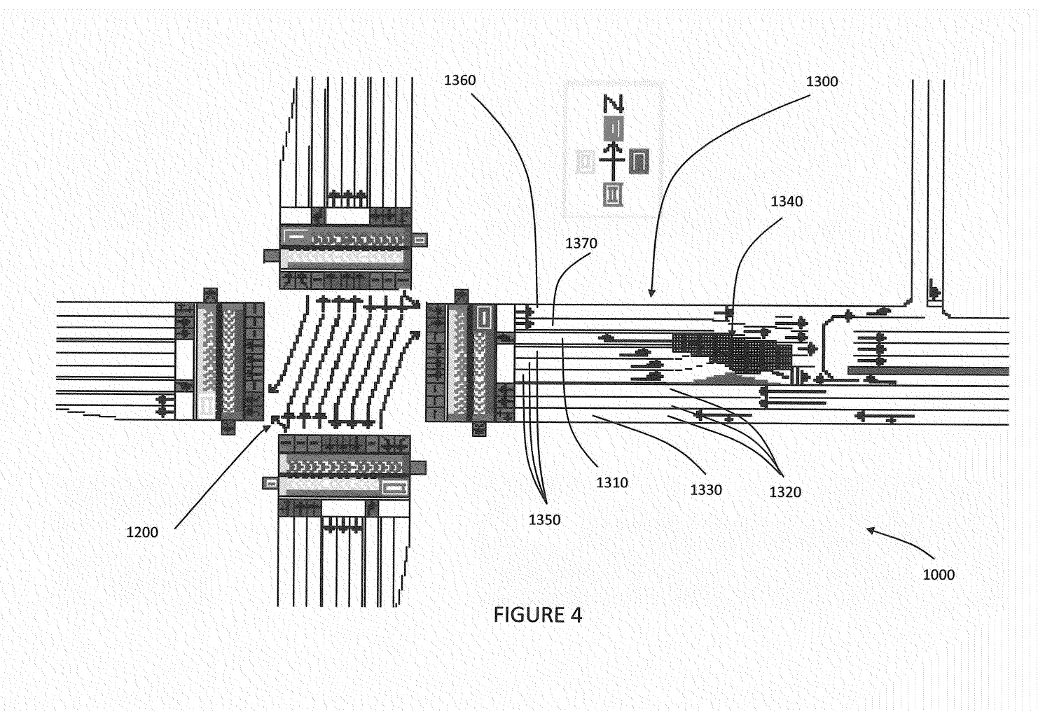

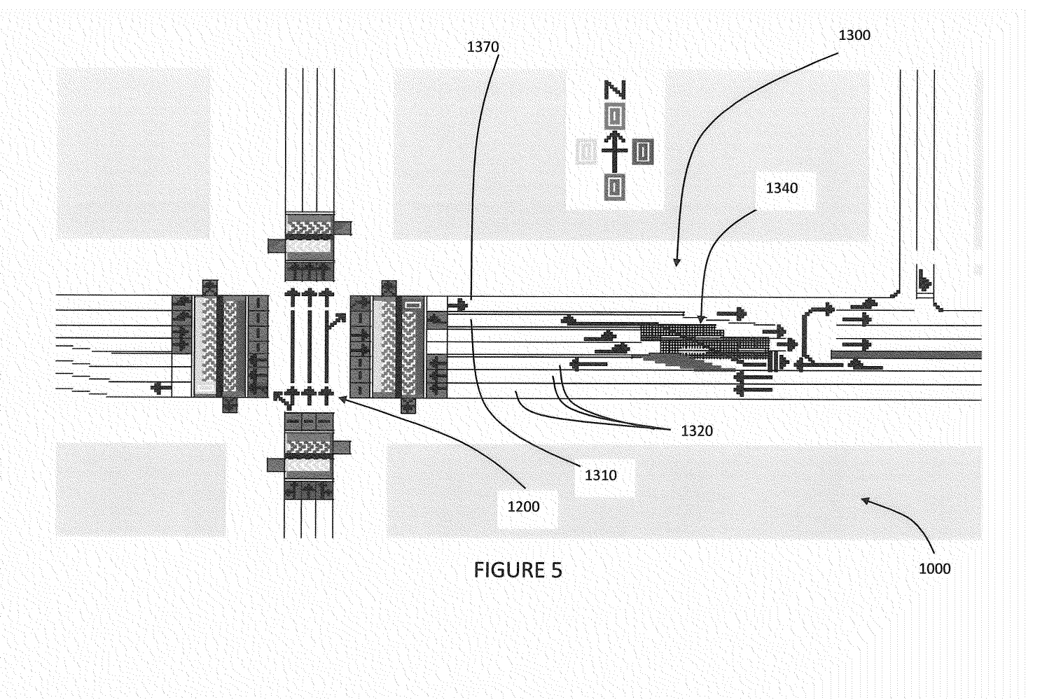

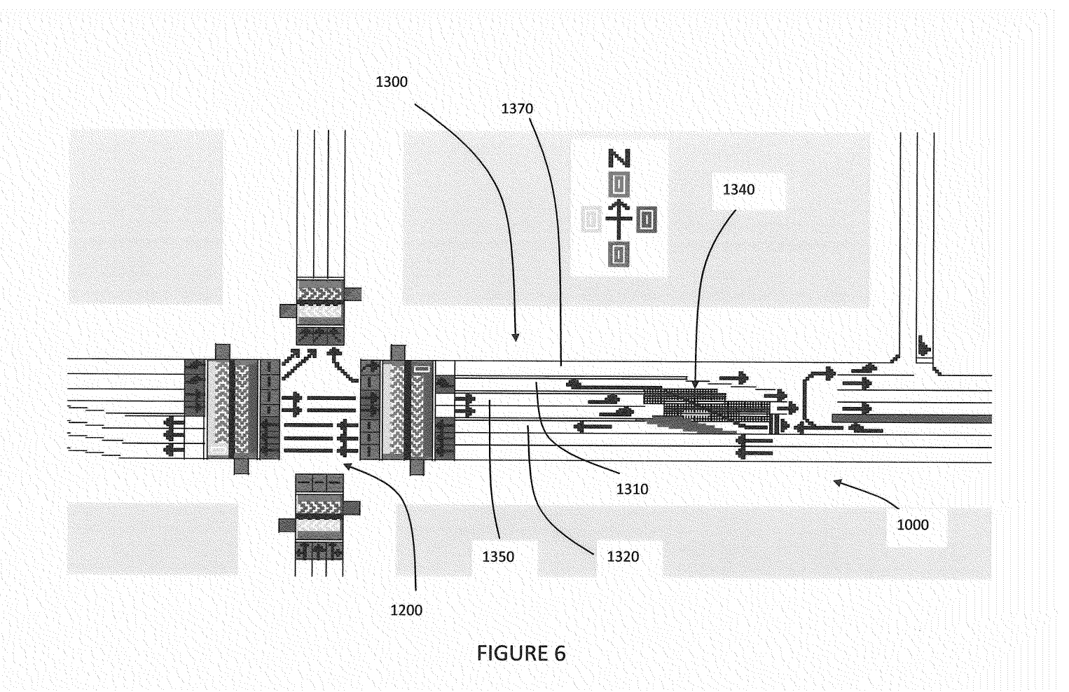

Described now are exemplary embodiments. Referring now to the figures of the drawings in detail and first, particularly to FIGS. 1 to 6, there is shown a first exemplary embodiment of a traffic intersection 1000. The traffic intersection 1000 is located at an intersection of two multilane roads 1100. Each road comprises a plurality of traffic lanes 1110. Each traffic lane 1110 is based one vehicle spacing apart, allowing for safety barriers and/or pedestrian islands.

The traffic intersection 1000 comprises an intersection region 1200 where the surface area of the intersecting roads substantially overlap, and proximate region 1300 that is located proximate the intersection region 1200. The proximate region 1300 includes a turning right lane 1310 for guiding vehicles to turn left at the intersection on to the intersecting road 1100. The proximate region 1300 further includes a going straight lane 1320 for guiding vehicles to move straight through the intersection on the same road 1100. Only these two lanes would be required for an intersection of a first road that has vehicles moving in opposed directions with a second road that has vehicles moving in only one direction.

However, where the intersection is an intersection of two roads that each have vehicles moving in opposed directions, then the going straight lane 1320 may be configured to guide vehicles to turn left on to the intersecting road 1100, or alternately and/or additionally, a turning left lane 1330 may be provided specifically for that purpose.

In an exemplary embodiment, the proximate region 1300 further comprises one or more receiving lanes for receiving vehicles moving art of the intersection region 1200.

The proximate region 1300 comprises a going straight receiving lane for receiving vehicles moving from the intersection region 1200 that have not turned into the proximate region 1300 from the intersecting road 1100. These vehicles will have moved straight across the intersection region 1200 along the same road, although they may have moved one or more vehicle spacings to the right as they crossed the intersection region 1200.

The proximate region 1300 further preferably comprises at least one or more turning left receiving lane 1360, for receiving vehicles that have traversed through the intersection region 1200 after turning left from the intersecting road 1100.

The proximate region 1300 further comprises at least one or more turning right receiving lane 1370, for receiving vehicles that have traversed through the intersection region 1200 after turning right from the intersecting road 1100.

It is envisaged that the turning left receiving lane 1360 and the turning right receiving lane 1370 will be aligned towards the left-hand side of the proximate region 1300 (into which the direction the vehicles are travelling).

Importantly, the turning right lane 1310 is configured to split away from the going straight lane 1320 in the proximate region 1300 by guiding vehicles through a crossover zone 1340. The going straight lane 1320 for guiding vehicles having travelled across the intersection region 1200 from an opposite direction and moving away from the intersection region 1200, will extend between the turning right lane 1310 and the going straight lane 1320 for vehicles moving towards the intersection region 1200.

In this way, vehicles coming from an opposite direction and having travelled through the intersection region 1200 in a going straight lane 1320, now moving along an opposed going straight receiving lane 1350, will move between vehicles travelling on the going straight lane 1320 and turning right lane 1310 of vehicles approaching the intersection region 1200 in the proximate region 1300.

Vehicles travelling away from the intersection region 1200 will be guided by the opposed going straight lane 1350 to the crossover zone 1340, where they will cross over back to the left-hand side of the road by moving at least one or more vehicles spaces to the left.

In an exemplary embodiment shown in the figures, each of the going straight lanes 1320 is configured to guide vehicles to move at least one vehicle spacing to the right as they move through the intersection region 1200.

It will be appreciated that, while the individual lanes have been described as if one lane is necessary for each function, this need not necessarily be the case. Where one lane can logically function, for example, as a lane for guiding cars that want to move straight as well as turn left, or as a lane for guiding cars that want to move straight as will turn right, then a single lane may be used.

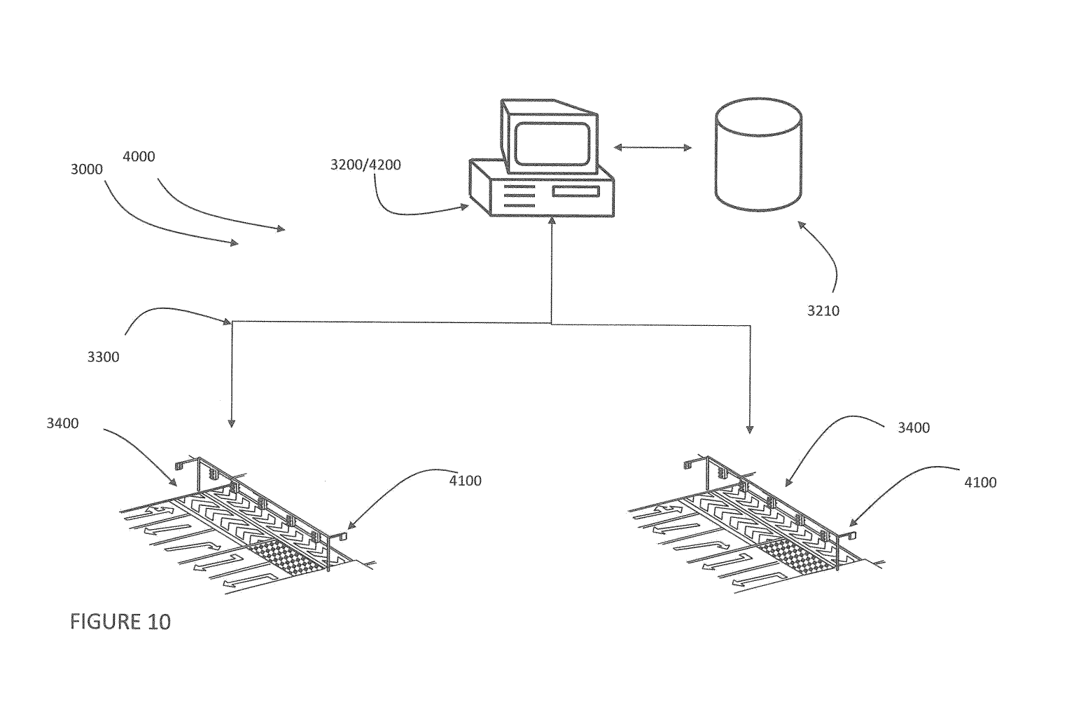

It is envisaged that the traffic intersection 1000 will include a traffic guidance system 3000 (see FIG. 10), for safely directing vehicles on the roads through the traffic intersection 1000. The traffic guidance system 3000 preferably comprises a set of visual signaling devices 3100 such as illuminated signs or the like. The visual signaling devices 3100 are configurable in one of only two, or preferably three modes of operation. These modes of operation are a go condition in which vehicles are instructed to travel through the intersection region, a stop condition in which vehicles file instructed not to proceed through the intersection region, and a slow condition in which vehicles are instructed to slow down in preparation for receiving an instruction to stop.

It is understood that, in some countries, the normal mode of operation of traffic lights includes an amber light, a green light and a red light; while in other countries the normal mode of operation of traffic lights and uses a green or a red light.

In an exemplary embodiment, at least one visual signaling device will be apportioned to each of the lanes at one vehicle spacing apart, such as the turning right lane, going straight lane, turning left lane, going straight receiving lane, turning right receiving lane, and turning left receiving lane (except where one lane is used for two of these, in which case the visual signaling device will be configured to indicate that two of these options are possible).

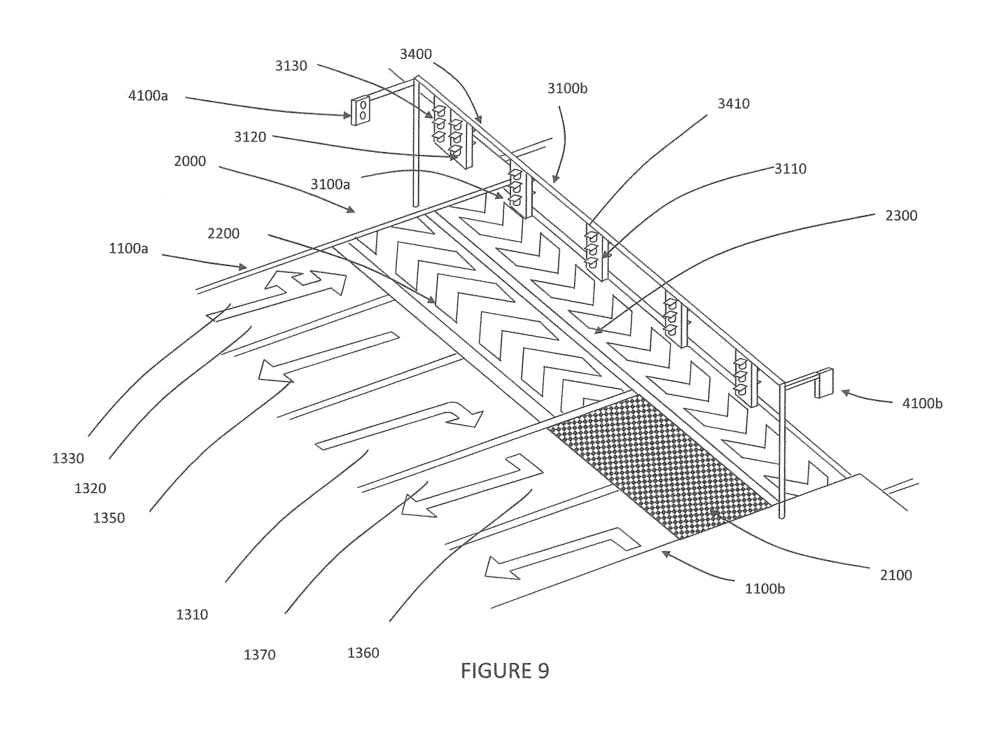

In particular, a turning right visual signaling device is provided for signaling to at least one turning right lane 1310 for guiding vehicles to turn right at the intersection onto the intersecting road. Further, a going straight visual signaling device 3120 (FIG. 9) is provided for signaling to at least one going straight lane 1320 for guiding vehicles to move straight to the intersection on the same road 1100.

For use in the traffic intersection 1000 described above, the turning right visual signaling device 3110 (FIG. 9) will be distanced from the nearest going straight visual signaling device 3120 by at least two vehicle spacings, as the turning right lane 1310 will be spaced from the going straight lane 1320 by at least one lane of the going straight receiving lane 1350.

In an exemplary embodiment, the traffic guidance system 3000 further comprises a turning left visual signaling device 3130 for signaling to at least one turning left lane for guiding vehicles to turn left at the intersection onto the intersecting road. This is anticipated as being aligned towards the left-hand side of the proximate region 1300 in the direction of vehicles travel.

As discussed previously, it is anticipated that the going straight lane in the proximate region can also be configured as a turning left lane for guiding vehicles to turn left at the intersection region onto the intersecting road. In a similar manner, the going straight right signaling device 3120 can be configured to indicate that it is possible for vehicles in that lane to turn left onto the intersecting road 1100 as well as go straight across the intersection region 1200.

In an exemplary embodiment, the traffic guidance system 3000 comprises a controller 3200 for controlling operation of one or more of the visual signaling devices 3100 to switch between their stop condition, go condition and slow condition.

The controller 3200 preferably comprises a processor (not shown) configured for receiving instructions from digital storage medium 3210, as well as digital storage media configured for storing digital instructions (not shown). The controller 3200 is connected or connectable to the visual signaling devices 3100 by a diagrammatically depicted network 3300. The network 3300 can be a wireless network or a hardwired network.

In an alternative embodiment, it is envisaged that the controller 3200 can be remotely located and be connected to the visual signaling devices 3100 by a long-distance network. The network 3300 can be the Internet, although this is not preferred.

The digital instructions can be in the form of software that is stored on one or more digital storage mediums 3210, such as a hard disc, a server center, or a cloud-based storage server.

It is further envisaged that a plurality of traffic guidance systems may be controlled by the controller, to thereby allow traffic to flow at more optimal levels through a plurality of traffic intersections 1000. In one exemplary embodiment, the controller comprises digital storage media for storing digital instructions.

In one embodiment, the controller is configured for controlling the visual signaling devices to switch between their stop condition, go condition and slow condition.

The modes or conditions of operation of the visual signaling devices described above are similar to those found in common traffic lights, and should be readily understood by vehicle drivers. However, currently available traffic intersections, as well as the traffic guidance systems that guide traffic through them, do not have lane markings that configured to guide vehicles from one road onto an intersecting road across the flow of oncoming traffic, while being guided via the intersection by a traffic guidance using one of only two, or preferably three configurations.

It will be appreciated that the visual signaling devices 3100 can operate using only the stop condition and the go condition, however a reversion to the traditionally understood configurations is beneficial for the sake of increased safety.

In this way, traffic congestion caused by vehicles turning across the flow of traffic (for example, in turning right lanes) is dissipated by moving the potential conflict to a distance away from the intersection region 1200.

It is anticipated that, at the crossover zone 1340, one of either of the vehicles moving into the turning right lane 1310, or vehicles moving along the opposed going straight lane 1350, will have right of way to move through the crossover zone 1340.

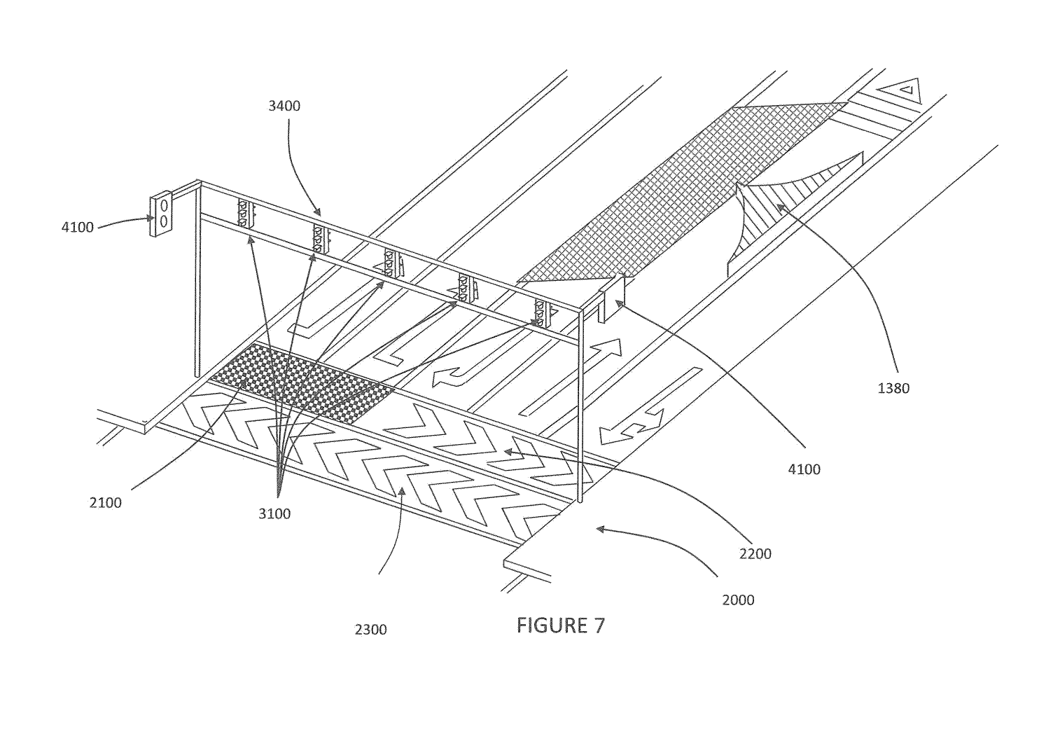

In the exemplary embodiment shown in FIGS. 7, 8 and 13, vehicles approaching the intersection 1000 and moving into the turning right lanes 1310 will give way to vehicles moving directly across the intersection and along the going straight receiving lane 1350. In this regard, an intermediate signaling arrangement in the form of a yield sign 1395 is provided to signal vehicles approaching the crossover zone, and a stop line 1390 is provided by which the vehicles giving way must stop. In an alternative embodiment, it is envisaged that the yield sign 1395 can be replaced with a visual signaling device such as a traffic light (not shown).

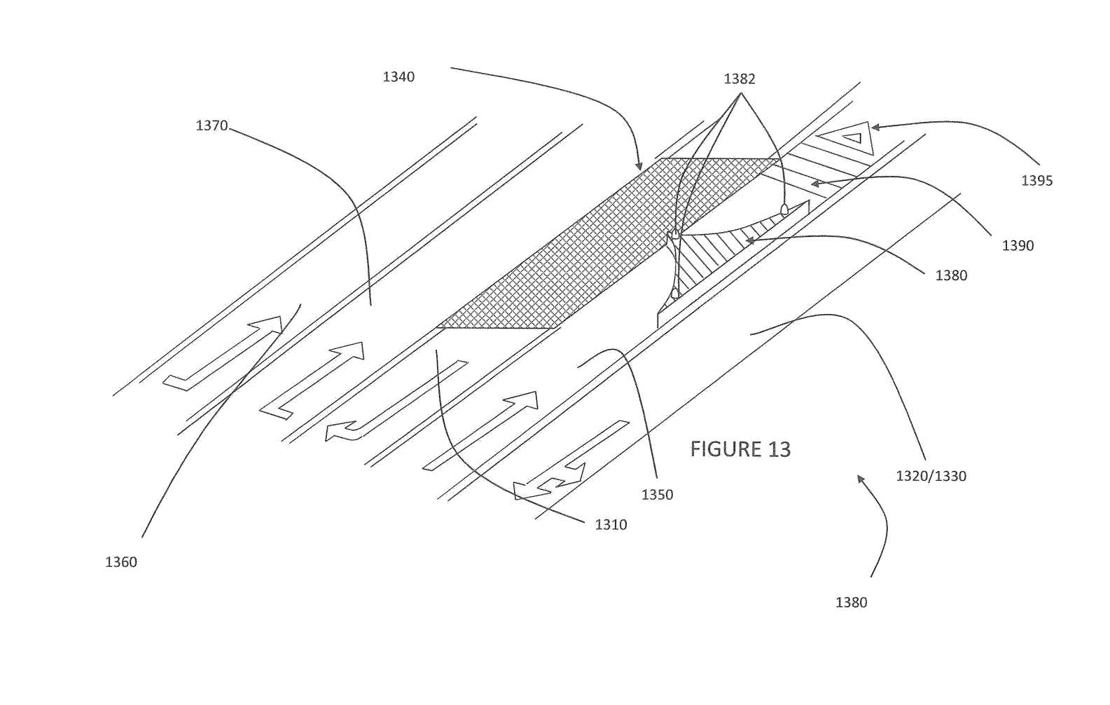

There is further provided a guiding formation 1380 that is raised and serves to guide approaching vehicles into the crossover zone 1340. In an exemplary embodiment shown in FIG. 13, the guiding formation 1380 is provided with flashing lights 1382 to alert vehicles to the presence of the guiding formation 1380.

Further, using such a system, only two configurations or modes of operation of the traffic guidance system are required, namely a stop condition and a go condition. At most, three configurations may be required, these being a stop condition, a go condition and a slow condition corresponding to know traffic light signals.

By using the visual signaling devices and one of only two, or at most three, modes or conditions, resulting in the traffic guidance system being operable an only two, or at most three, configurations at the intersection of two multilane roads, it is anticipated that time delays spent waiting for various turning configurations to be presented to guide vehicles turning across the flow of traffic will be reduced, allowing for increased time intervals (which means a lower proportion of time spent with vehicle standing at a halt or accelerating from a stop) and flow of traffic along the roads will be less congested.

Improved Traffic Intersection with Bicycles

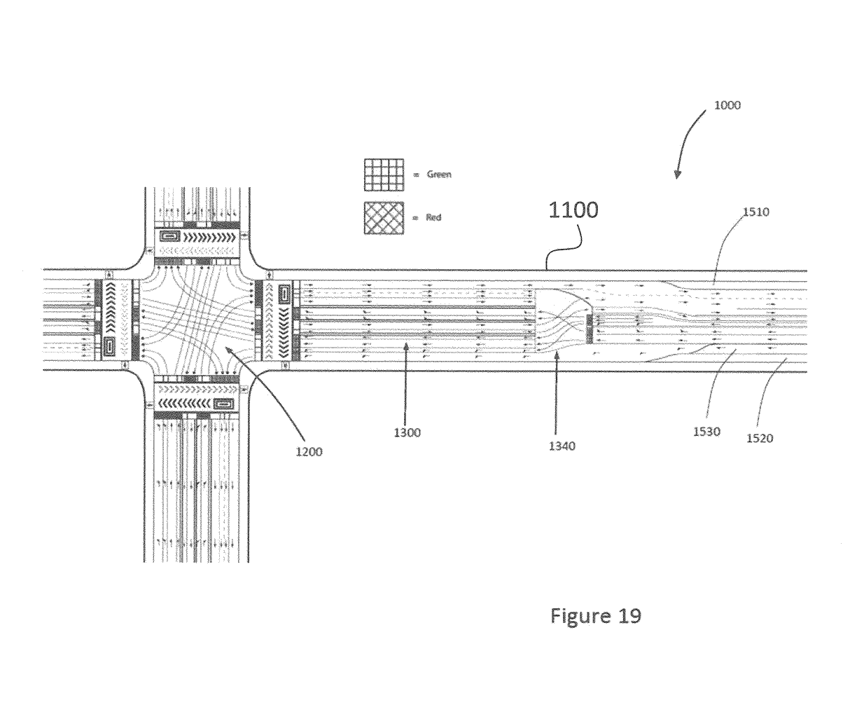

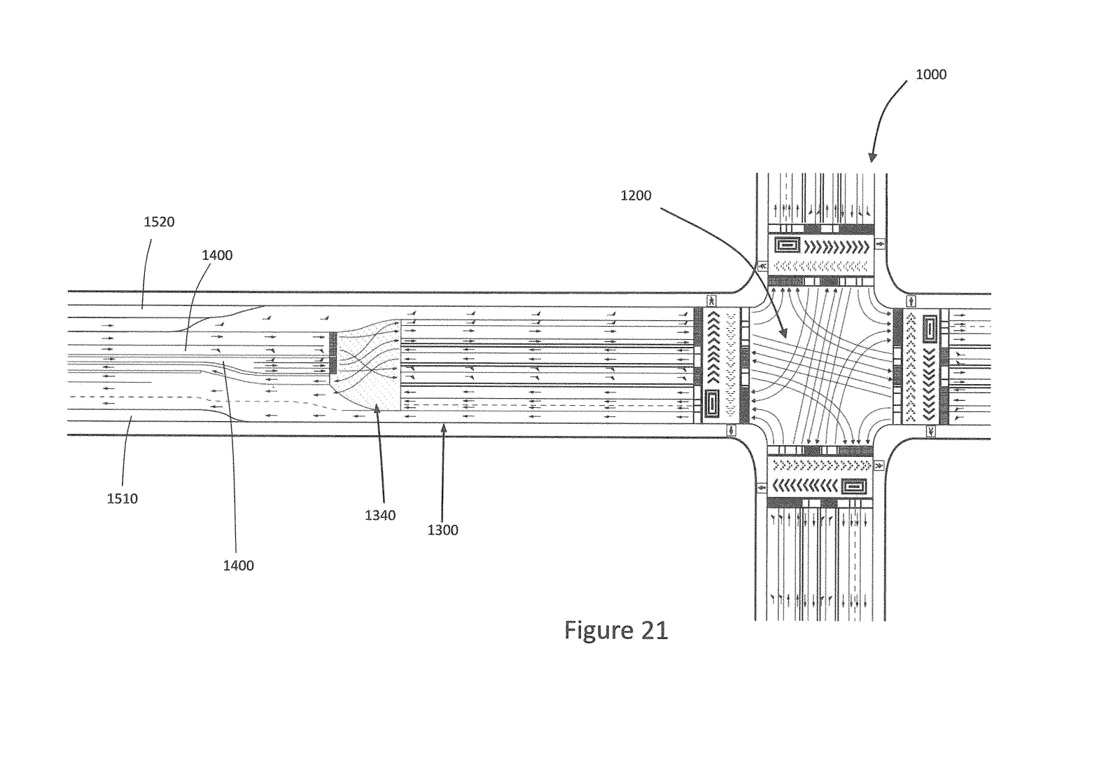

Alternative embodiments of a traffic intersection 1000 are shown in FIGS. 19-28, in which bicycle lanes are provided. In a region distal to the crossover zone 1340 from the intersection region 1200, a pair of bicycle lanes 1400 are provided, extending along the center of the road 1100. Each of the bicycle lanes 1400 is for guiding bicycles moving in opposite directions. In alternative embodiments, more than two opposing bicycle lanes 1400 can be provided.

It is envisaged that the intermediate visual signaling arrangement(s), either in the form of road markings or preferably in the form of traffic lights, can be configured to signal to bicycles in the bicycle lanes 1400 as well as to vehicles in the opposing traffic lanes 1110.

As the bicycle lanes move into the proximate region approximate the intersection region 1200, the bicycle lanes 1400 will split up into separated lanes in a similar fashion to the way that the traffic lanes 1100 are split up.

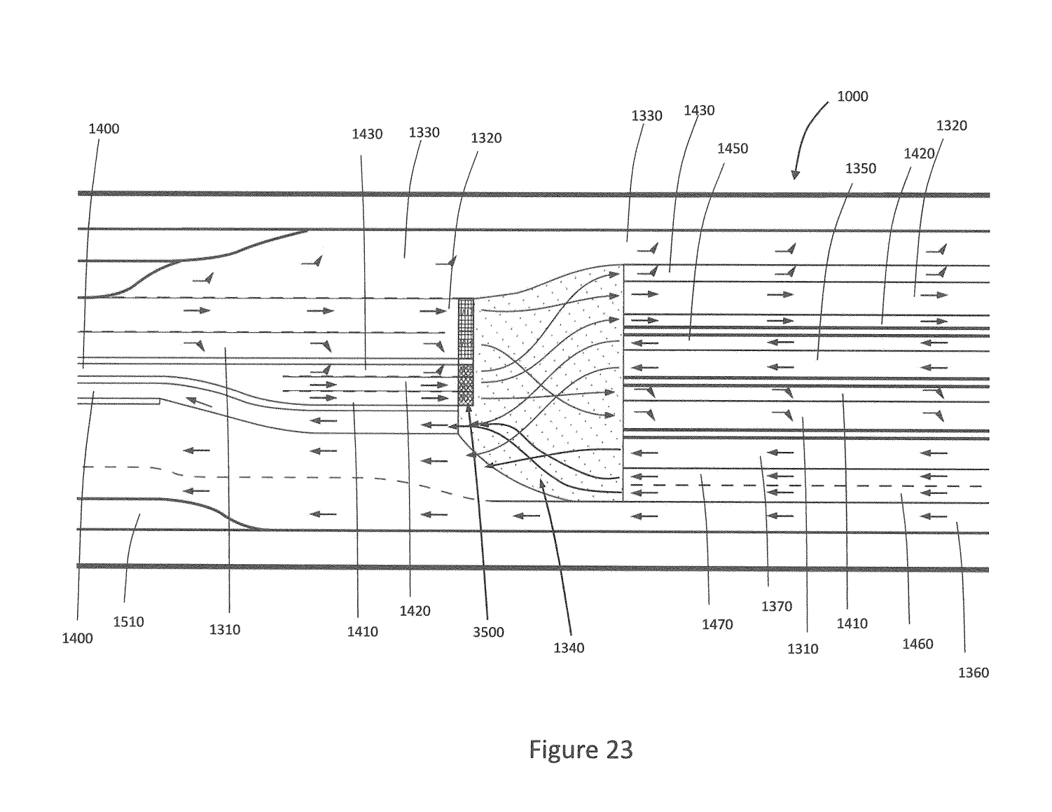

In the embodiments shown in the figures, the proximate region is configured to present a turning right bicycle lane 1410 (FIG. 23) associated with the turning right lane 1310, the turning right bicycle lane 1410 being configured for guiding bicycles to turn right at the intersection onto the intersecting road (on a left-hand side drive road). The proximate region is further configured to present a going straight bicycle lane 1420 associated with the going straight lane 1320, the going straight bicycle lane 1420 being configured for guiding bicycles to move straight through the intersection on the same road.

The turning right bicycle lane 1410 is, similar to the turning right lane 1310, configured to split from the going straight bicycle lane 1420 in the proximate region by crossing through the crossover zone 1340, so that vehicles and/or bicycles travelling straight through the intersection 1000 in an opposite direction along the same road are guided to move between the turning right bicycle lane 1410 and the going straight bicycle lane 1420.

In the embodiments shown, the proximate region 1300 is also configured to present a turning left bicycle lane 1430 associated with the turning left lane 1330, the turning left bicycle lane 1430 being configured for guiding bicycles to turn left at the intersection region onto the intersecting road.

In addition to the bicycle lanes guiding bicycles towards the intersection, the proximate region includes bicycle lanes for guiding bicycles coming from the intersection. As shown in the figures, the proximate region comprises at least one going straight receiving bicycle lane 1450 associated with, and preferably running alongside, the going straight receiving lane 1350. The going straight receiving bicycle lane 1450 is configured for receiving and guiding a bicycle going straight over the intersection.

Further, the proximate region further comprises a turning right receiving bicycle lane 1470. The turning right receiving bicycle lane 1470 is associated with the turning right receiving lane 1370. The turning right receiving bicycle lane 1470 is configured for receiving and guiding a bicycle turning right from the intersecting road through the intersection region 1200.

Similarly, the proximate region 1300 comprises a turning left receiving bicycle lane 1460 associated with the turning left receiving lane 1360. The turning left receiving bicycle lane 1460 is configured for receiving and guiding a bicycle turning left from the intersecting road through the intersection region 1200.

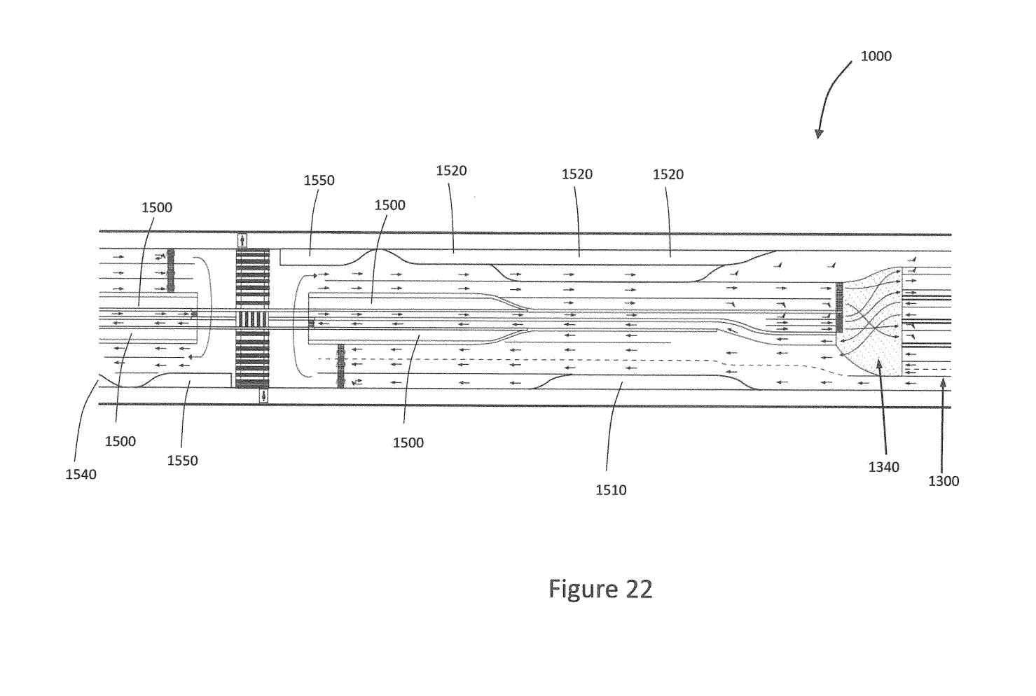

In one exemplary embodiment, the traffic intersection 1000 comprises bicycle storage zones 1500 (FIG. 22) that are located alongside the centrally aligned bicycle lanes 1400 in the region distal to the crossover zone.

In addition, it is envisaged that the road in the region

In one embodiment, the road 1100 in the region distal to the crossover zone 1340 can be configured to providing any one or more of the following:

a. parking bays 1510 (FIG. 22);

b. bicycle hire zones 1520 (FIG. 22);

c. bus/taxi only lanes 1530 (FIG. 19);

d. bus stop zones 1540 (FIG. 22); and

e. a taxi rank 1550 (FIG. 22).

As may be seen in one exemplary embodiment shown in FIG. 23, the traffic intersection 1000 includes bicycle signaling devices 3500 in the form of traffic lights at the intersection region 1200.

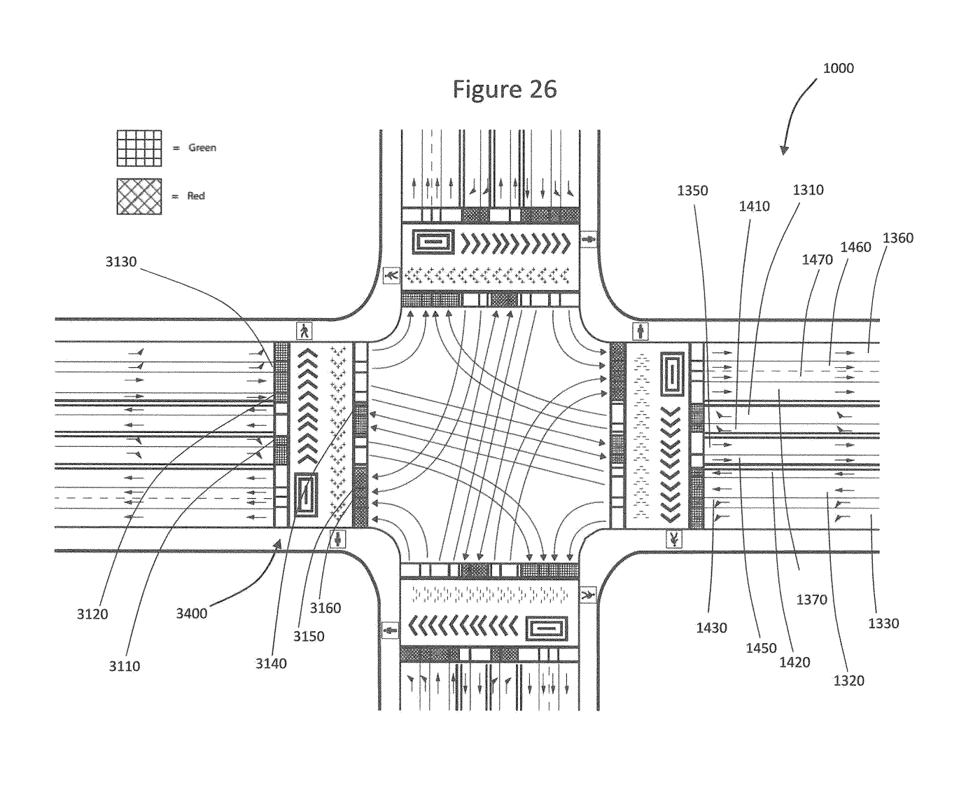

More specifically, a turning right bicycle visual signaling device 3110 (FIG. 26) is provided for visually signaling bicycles in the turning right bicycle lane 1410 to turn right safely through the intersection region 1200, a going straight bicycle visual signaling device 3120 is provided for visually signaling to bicycles in the going straight bicycle lane 1420 to move safely across the intersection region 1200, and turning left bicycle visual signaling devices 3130 are provided for visually signaling to bicycles in the turning left bicycle lane 1430 to safely guide a bicycle turning left into the intersecting road.

Naturally, and as illustrated in FIG. 23, the crossover zone 1340 can also be adapted to allow for the crossover of bicycles and vehicles from their lanes in the region distal to the crossover zone 1340, to their lanes in the proximate region 1300. The crossover zone 1340 is adapted to allow for one or more selected from the following:

a. the crossing of vehicles in the going straight lane 1320 with bicycles in the turning right bicycle lane 1410;

b. the crossing of vehicles in the turning left lane 1330 with vehicles in the going straight receiving lane 1350;

c. the crossing of vehicles in the turning left lane 1330 with bicycles in the going straight receiving bicycle lane 1450;

d. the crossing of vehicles in the turning left lane 1330 with bicycles in the turning right bicycle lane 1410;

e. the crossing of vehicles in the turning left lane 1330 with bicycles in the going straight bicycle lane 1420;

f. the crossing of bicycles in the turning left bicycle lane 1430 with bicycles in the going straight receiving bicycle lane 1450;

g. the crossing of bicycles in the turning left bicycle lane 1430 with vehicles in the going straight receiving lane 1350;

h. the crossing of vehicles in the turning left receiving lane 1360 with bicycles in the turning right receiving bicycle lane 1470;

i. the crossing of vehicles in the turning left receiving lane 1360 with bicycles in the turning left receiving bicycle lane 1460;

j. the crossing of vehicles in the going straight receiving lane 1350 with bicycles in the turning right receiving bicycle lane 1470; and

k. the crossing of vehicles in the going straight receiving lane 1350 with bicycles in the turning left receiving bicycle lane 1460.

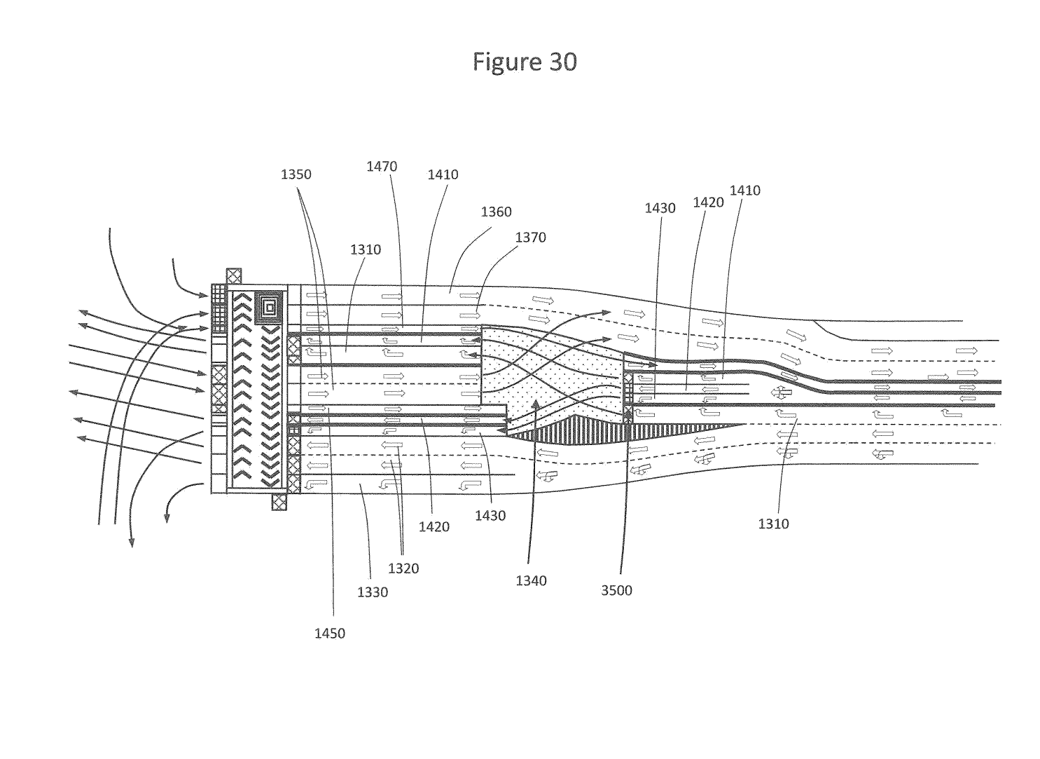

In one embodiment shown in FIG. 30, bicycles in the turning left bicycle lane 1430 need not necessarily cross paths with vehicles in the going straight lane 1320. As shown in FIG. 30, bicycles in the turning left bicycle lane 1430 are guided over the crossover zone 1340 to run alongside the right-hand side of the going straight lane 1320, while in FIG. 23, bicycles in the turning left bicycle lane 1430 are guided over the crossover zone 1342 run alongside the left-hand side of the going straight lane 1320. It is envisaged that, if the bicycles in the turning left bicycle lane 1430 are guided to run alongside the right-hand side of the going straight lane 1320, then the turning left bicycle visual signaling device 3130 will typically be stopped when vehicles in the going straight lane 1320 are moving through the intersection.

Further, it is envisaged that the traffic intersection will include bicycle intermediate signaling arrangements and vehicle intermediate signaling arrangements (preferably in the form of traffic lights) that are configured for signaling bicycles and vehicles respectively, that are approaching the crossover zone moving towards the intersection region 1200. In one embodiment as shown in FIG. 23, the vehicle intermediate signaling arrangement is configured for signaling vehicles approaching the crossover zone in the going straight lane 1320 and the vehicle turning right lane 1310. Also, the bicycle intermediate signaling arrangement is configured for signaling bicycles approaching the crossover zone from a region distal to the intersection region 1200 in the going straight bicycle lane 1420, the turning left bicycle lane 1430 and the turning right bicycle lane 1410.

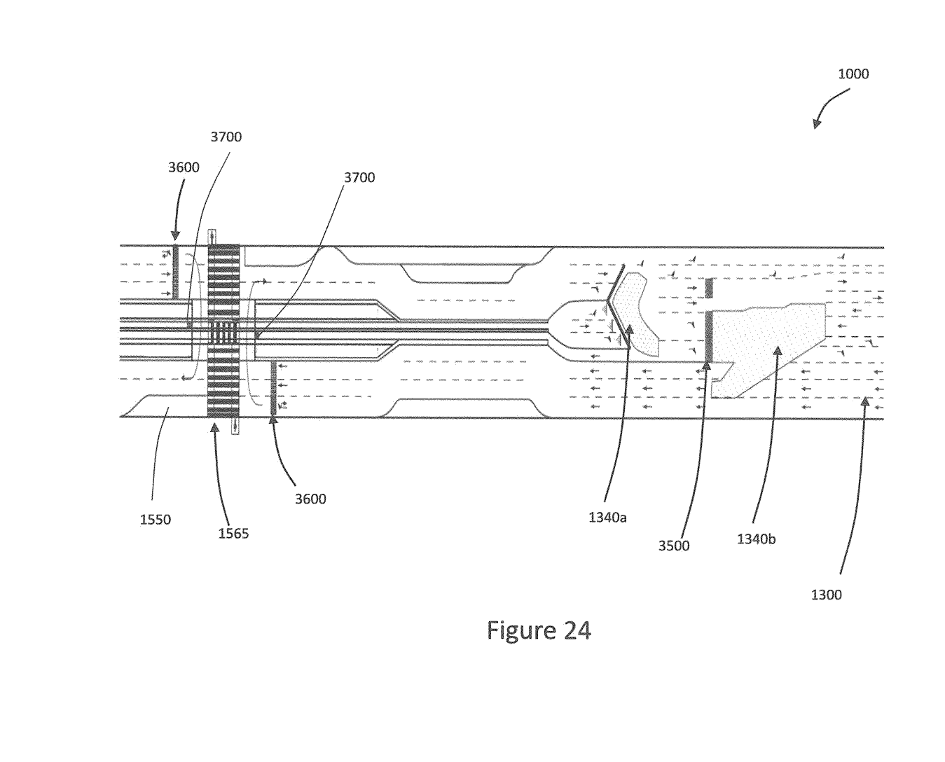

In another embodiment, shown in FIGS. 24, 25, 27 and 28, the crossover zone 1340 comprises a first crossover zone 1340a distal to the intersection region and a second crossover zone 1340b more proximate to the intersection region 1200.

It is envisaged that the traffic intersection 1000 can include one or more intermediate lanes, some of which extend between the first crossover zone 1340a and the second crossover zone 1340b. For example, a turning right intermediate bicycle lane 1410a for bicycles and a turning right intermediate lane 1310a for vehicles extends between the second crossover zone 1340b and the first crossover zone 1340a. In this embodiment, intermediate visual signaling arrangements 3500 in the form of traffic lights are located between the first crossover zone 1340a and the second crossover zone 1340b, and are configured to provide visual indications to vehicles or bicycles in these intermediate lanes 1430a & 1330a.

In this embodiment, the first crossover zone 1340a is adapted to allow for one or more selected from:

a. bicycles in the turning left bicycle lane 1430 to cross paths with vehicles in the turning right lane 1330;

b. bicycles in the going straight bicycle lane 1420 to cross paths with vehicles in the turning right lane 1330;

c. bicycles in the turning right bicycle lane 1410 to cross paths with vehicles in the turning right lane 1330; and

d. bicycles in the turning left bicycle lane 1410 to cross paths with vehicles in the going straight lane 1320.

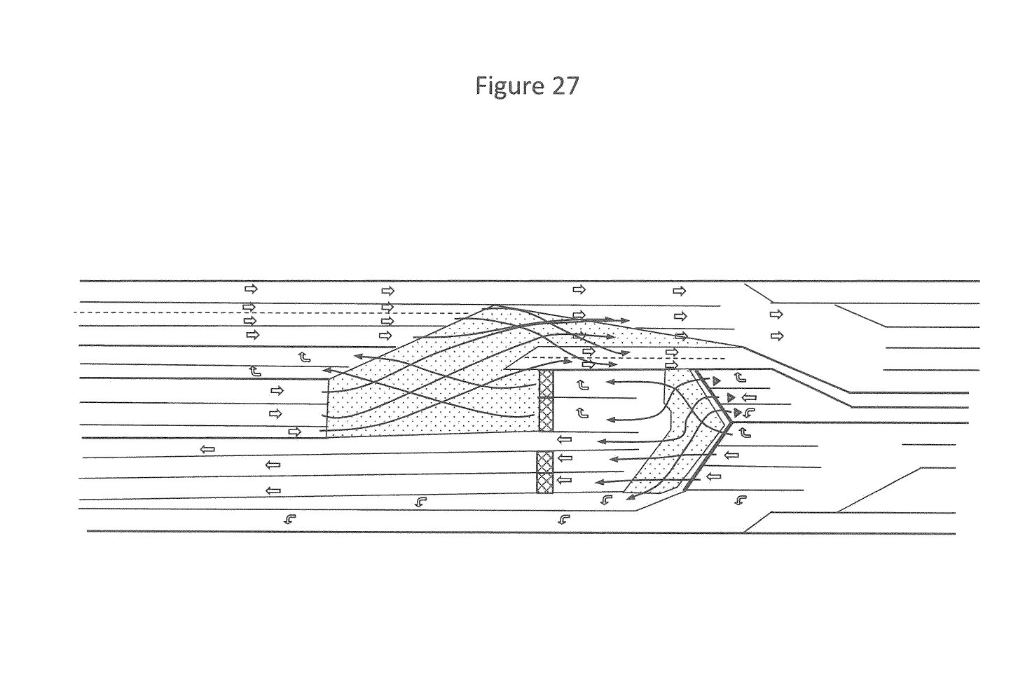

In addition, it is envisaged that more intermediate visual signaling arrangements 3500 can be provided to signal vehicles and/or bicycles in any of the lanes in the region between the first crossover zone 1340a and the second crossover zone 1340b. As shown in FIG. 27, an intermediate visual signaling arrangement 3500 is provided to signal vehicles in a going straight intermediate lane 1320a.

The second crossover zone 1340b is adapted to allow for one or more selected from:

a. bicycles in the turning right bicycle lane 1410 to cross paths with bicycles in the going straight receiving bicycle lane 1450;

b. bicycles in the turning right bicycle lane 1410 to cross paths with vehicles in the going straight receiving lane 1350;

c. vehicles in the turning right lane 1310 to cross paths with bicycles in the going straight receiving bicycle lane 1450;

d. vehicles in the turning right lane 1310 to cross paths with vehicles in the going straight receiving lane 1350;

e. vehicles in the turning right receiving lane 1370 to cross paths with bicycles in the turning right receiving bicycle lane 1470;

f. vehicles in the turning right receiving lane 1370 to cross paths with bicycles in the turning left receiving bicycle lane 1460;

g. vehicles in the going straight receiving lane 1350 to cross paths with bicycles in the turning right receiving bicycle lane 1470; and

h. vehicles in the going straight receiving lane 1350 to cross paths with bicycles in the turning left receiving bicycle lane 1460.

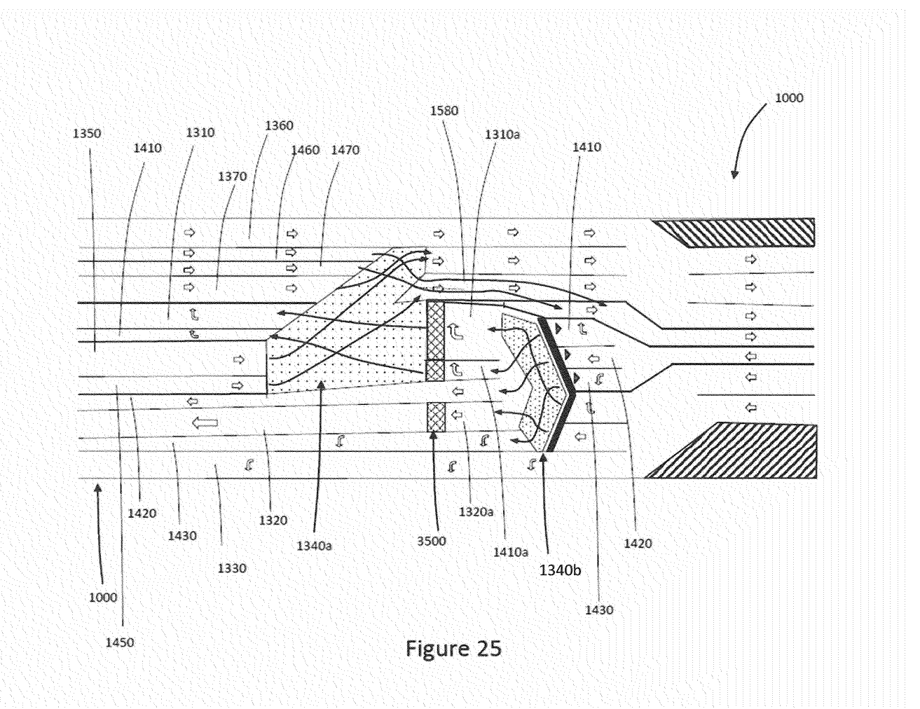

It is envisaged that the time will be staggered between when bicycles in the turning left receiving bicycle lane 1460 and the turning right receiving bicycle lane 1370 are required to use the seconds crossover zone 1340b, and vehicles in the turning right lane 1310 and going straight lane 1320 are required to use the second crossover zone 1340b (since vehicles generally pull off faster than bicycles). This is why a portion of the vehicle lanes after the second crossover zone 1340, may be used as a dual use lane 1580 (shown in FIG. 25) that can be used by both vehicles and bicycles at different times.

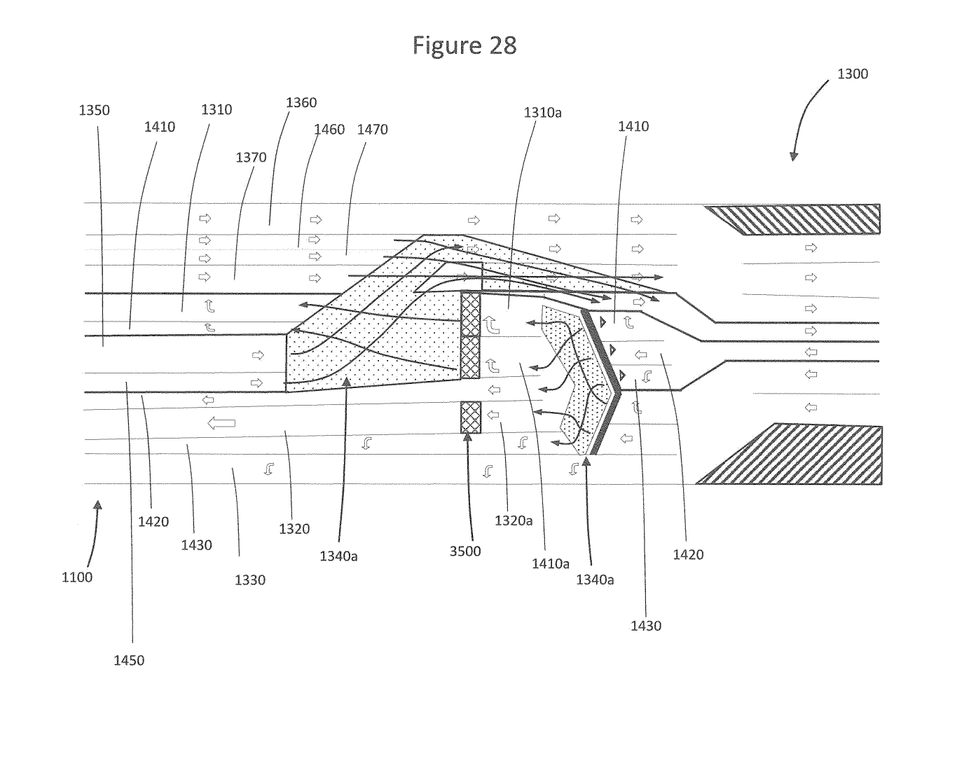

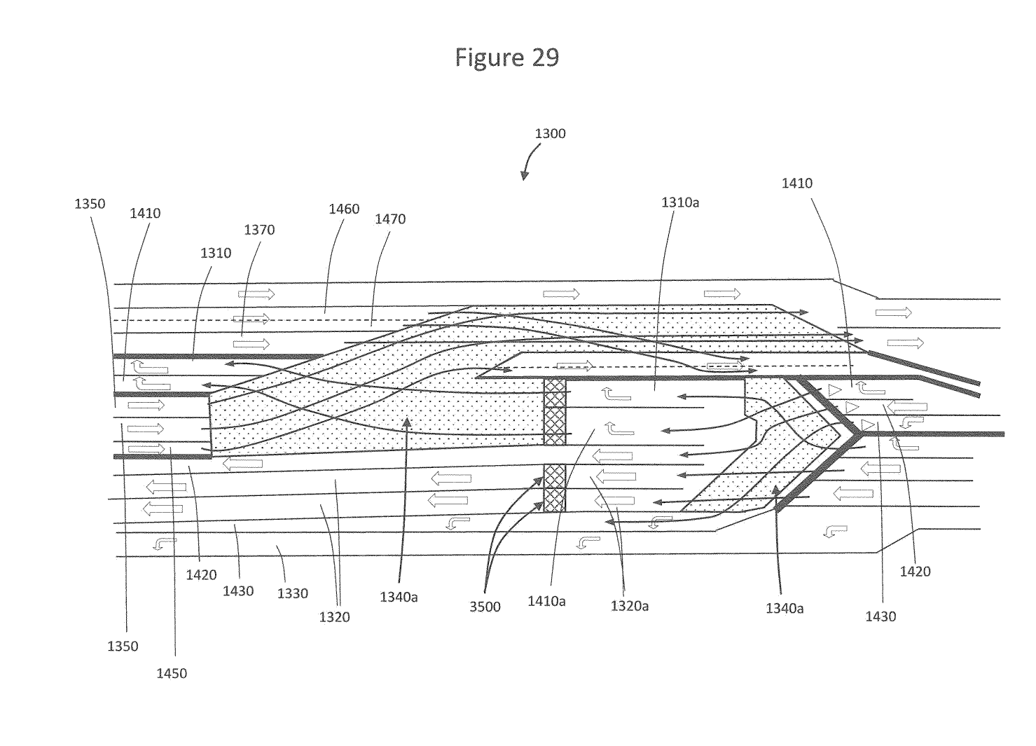

Alternately, the second crossover zone 1340b can be extended over the area of the dual use lane 1580 as shown in FIGS. 27 and 28. In such a case, it is envisaged that either of the vehicles and the bicycles in any of the receiving lanes can be subject to a rule, and a road marking (not shown), to yield for the other of the bicycle and the vehicles in the receiving lanes. Preferably, bicycles in the going straight bicycle receiving lanes will yield for vehicles in the going straight receiving lane, and bicycles in the turning left/right receiving bicycle lane will yield for vehicles in the turning right receiving lane.

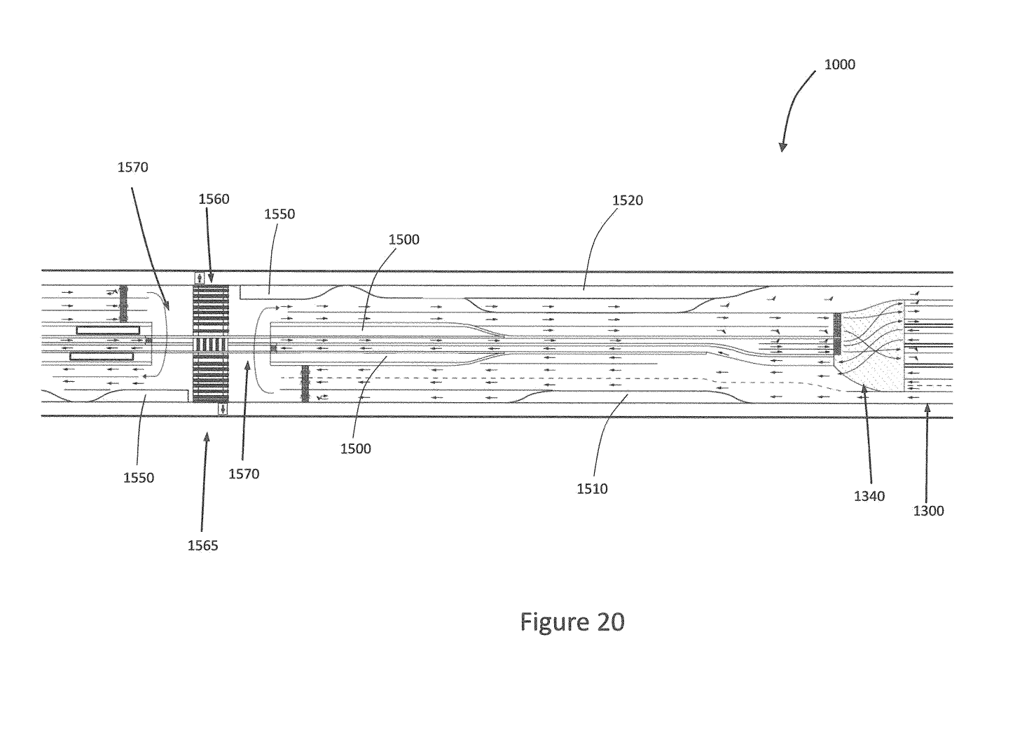

It is further envisaged that the traffic intersection 1000 can comprise a pedestrian crossing 1560 (FIG. 20) located distally of the crossover zone from the intersection region 1200 in a pedestrian crossing region 1565. The pedestrian crossing region 1565 comprises a U-turn region 1570 or zone in which vehicles can do U-turns on the road. The U-turn region 1570 is located adjacent and to either side of the pedestrian crossing 1560. Pedestrian crossing vehicle visual signaling devices 3600 (FIG. 24), e.g., in the form of traffic lights, are configured for signaling to vehicles in an outer lane that they are able to perform a U-turn on the road, while vehicles in a lane inwardly of the outer lane are stopped. Additionally, pedestrian crossing bicycle visual signaling devices 3700 are provided that are configured for bringing bicycle traffic to a halt to allow vehicles to do U-turns in the U-turn region 1570.

Traffic Signaling Arrangement

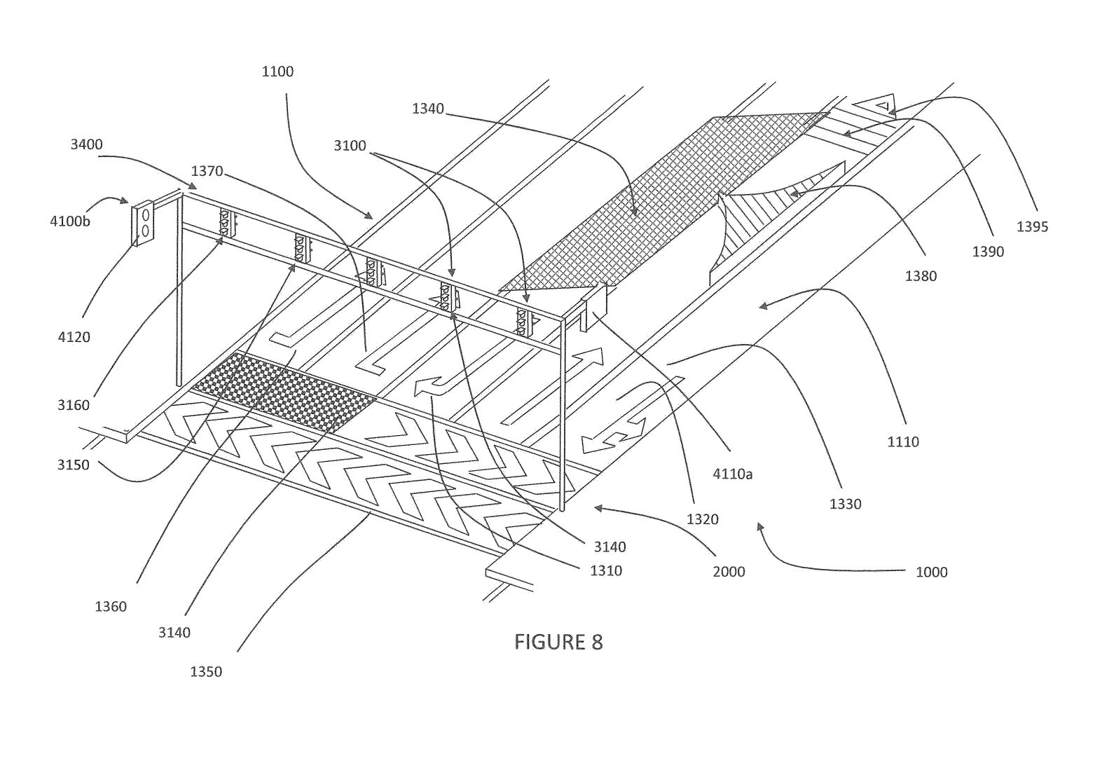

It is anticipated that a traffic signaling arrangement 3400 (see FIG. 7) will be provided across each road 1100 in the proximate region 1300, and at or towards each side of the intersection region 1200. The traffic signaling arrangement 3400 can span the width of the road 1100 on a frame 3410 (see FIG. 8). The frame 3410 is configured to support the visual signaling devices 3100 described above, above the road 1100.

It is anticipated that each traffic signaling arrangement 3400 will support a first set 3100a of visual signaling devices 3100 to display a visual signal in a first direction to vehicles approaching the intersection region 1200. The visual signaling devices will include at least at turning right visual signaling device 3110 (see FIG. 9) and a going straight visual signaling device 3120, and also a turning left visual signaling device 3130.

Each traffic signaling arrangement 3400 can also support a second set 3100b of visual signaling devices 3100. The second set 3100b of visual signaling devices 2100 will preferably include a receiving going straight visual signaling device 3140 (see FIG. 26) for guiding alignment of vehicles moving from the intersection region 1200 to continue moving straight on the same road 1100; an intersection right turn visual signaling device 3150 for guiding alignment of vehicles moving through the intersection region 1200 to turn right onto the intersecting road; and an intersection left turn visual signaling device 3160 for guiding alignment of vehicles moving through the intersection region 1200 to turn left onto the intersecting road 1100.

It will be appreciated that the visual signaling devices of each set 3100a and 3100b will be disposed in alignment with the lanes they are intended to guide (as described above), and spaced accordingly.

It will further be appreciated that many variants of a visual signaling device are possible that will be capable of carrying out the intended function of the visual signaling devices described. Many examples of these are known, including illuminated signs, traffic lights or the like, and a further explanation of possible embodiments is considered beyond the scope of this invention.

It is anticipated that, because the traffic intersection described above requires drivers to understand the nature of the intersection that they are approaching, such intersections will be signposted at or towards the start of the proximate region 1300. In this way, drivers will be made aware of the fact that they will need to cross the crossover zone 1340 at some stage if they wish to turn right, or carry on straight through the intersection 1000.

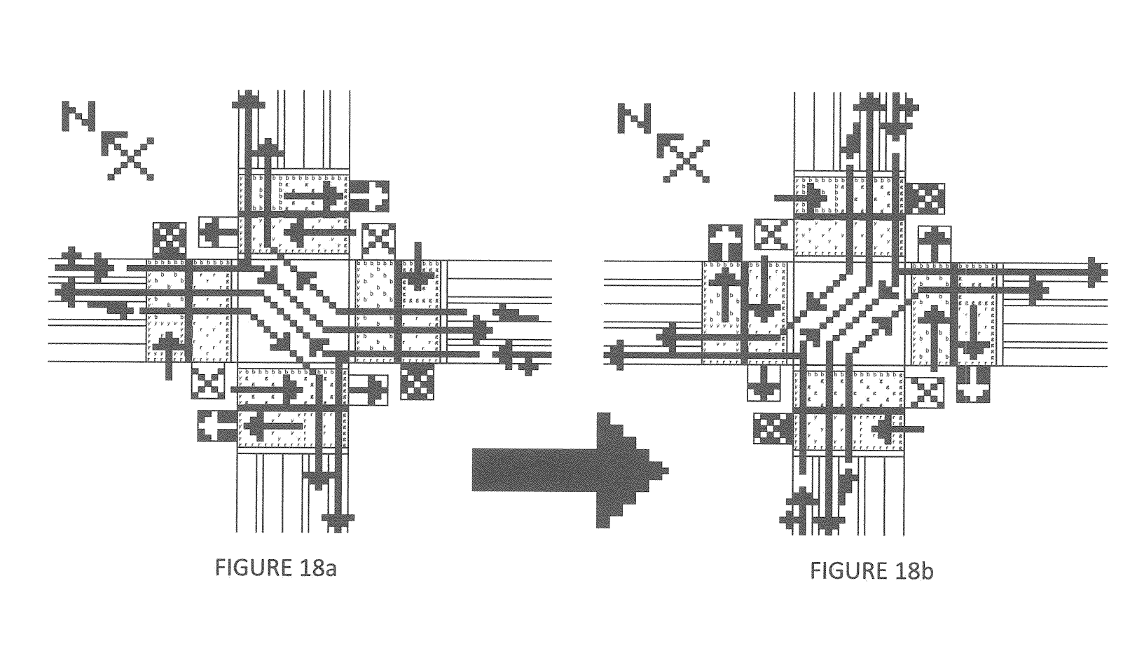

With reference to FIGS. 18a and 18b, a schematic diagram of the same traffic intersection is shown in two modes of operation in which vehicles (travelling along the vehicle lanes shown as arrows on the vehicle lanes traversing the intersection) are able to move up straight across the intersection, or turn to the left or right as may be applicable, without requiring a further mode of operation specifically for vehicles turning across the flow of traffic. In this way, a traffic intersection 1000 and a traffic guidance system 3000 is provided that is operable in two or three modes of operation, and allows vehicles at an intersection to turn into an intersecting road without having to provide separate modes of operation with traffic lights specifically for vehicles turning in a particular direction, which would reduce the available amount of time for vehicles to move in.

As mentioned in the description of the traffic intersection above, the traffic guidance system 3000 will further comprise and can also be networked to control the bicycle visual signaling devices 3400 including:

the turning right bicycle visual signaling device 3110;

the going straight bicycle visual signaling device 3120; and

the turning left bicycle visual signaling device 3130.

In addition, it is envisaged that the traffic guidance system 3000 will further comprise visual signaling devices configured for signaling to bicycles that are in the intersection region, and

have travelled through the intersection region while turning right from the intersecting road by an intersection right turn bicycle visual signaling device 3150;

have travelled through the intersection region while turning left from the intersecting road by an intersection left turn bicycle visual signaling device 3160; and

have travelled through the intersection region by travelling straight over it on the same road by an intersection going straight bicycle visual signaling device 3140.

Furthermore, the traffic guidance system 3000 can comprise and/or control operation of the intermediate traffic signaling devices 3500 described above, as well as the pedestrian crossing vehicle visual signaling devices 3600 described above, which guide vehicles when they are able to perform U-turns in the U-turn region.

Similarly, the traffic guidance system 3000 can comprise and/or control operation of the pedestrian crossing bicycle visual signaling devices 3700 (see FIG. 24) that stops bicycles in the bicycle lanes from moving while vehicles are performing U turns.

Operation of Traffic Signaling Arrangement

In one preferred embodiment, it is anticipated that the traffic signaling arrangement will operate according to the following text.

As mentioned previously, the traffic signaling arrangement will operate in one of two conditions. In a first condition, the following visual signaling devices 3100 will be operated simultaneously to signal for their respective lanes to proceed, preferably by indicating a green light to those lanes:

a. the turning left visual signaling device 3130;

b. the going straight visual signaling device 3120;

c. the turning right visual signaling device 3110; and

d. the intersection going straight visual signaling device 3140.

At the same time, in the first condition, the following visual signaling devices 3100 will be operated simultaneously to signal for their respective lanes to stop, for example, by indicating a red light to those lanes:

a. the intersection right turn visual signaling device 3150; and

b. the intersection left turn visual signaling device 3160.

In the second condition, the visual signaling devices 3100 described above will be reversed.

It is also anticipated that, when a vehicle visual signaling device 3100 at an intersection is operated, the corresponding bicycle visual signaling device will be operated synchronously.

At the crossover zone as shown in FIG. 30, and as mentioned above, it is anticipated that the crossover zone will be provided with intermediate traffic signaling devices 3500. In particular, it is envisaged that the crossover zone 1340 will be provided with:

a. an intermediate bicycle turning left visual signaling device 3510 configured for signaling to bicycles in the turning left bicycle lane approaching the crossover zone;

b. an intermediate bicycle going straight visual signaling device 3520 configured for signaling to bicycles in the going straight bicycle lane approaching the crossover zone;

c. an intermediate bicycle turning right visual signaling device 3530 configured for signaling to bicycles in the turning right bicycle lane approaching the crossover zone; and

d. an intermediate vehicle turning right visual signaling device 3540 configured for signaling to vehicles in the turning right lane approaching the crossover zone.

It is anticipated that when vehicles in the turning right lane and bicycles in the bicycle turning right lane approaching the crossover zone are directed to stop, then bicycles in the turning left bicycle lane and going straight bicycle lane approaching the crossover zone will be directed to go, and vice versa.

In another embodiment shown in FIG. 23, the bicycles in all of: the bicycle turning left lane; the bicycle going straight lane; and the bicycle turning right lane approaching the crossover zone will be directed to stop, while vehicles in the turning right lane and the going straight lane are directed to go through the crossover zone, and vice versa.

It will be appreciated that a wide variety of configurations are possible, with or without the provision of visual signaling devices 3100, bicycle lanes or bicycle visual signaling devices 3400. However, in this way, the congestion typically found at the intersection region 1200 is at least partially diverted to the proximate region 1300, allowing for more space and increased flow through the traffic intersection 1000.

In an alternative embodiment, it is envisaged that the traffic intersection 1000 may operate in more than two modes. This is especially the case where bicycle lanes are provided, together with bicycle visual signaling arrangements. It is especially anticipated that where a bicycles and vehicles may cross the crossover zone at the same time, the bicycle lanes will either be stopped by a bicycle visual signaling arrangement, in the form of a traffic light, or by a yield signal on the relevant bicycle lane.

Pedestrian Guidance System

In another aspect, and as described with reference to FIGS. 9 and 10, there is further provided a pedestrian crossing guidance system 4000 for guiding pedestrians across a pedestrian crossing 2000 at a first road 1100 near a traffic intersection of two multilane roads, and preferably at a traffic intersection as described above. In particular, the pedestrian crossing 2000 comprises a pedestrian waiting zone 2100 located in the path of a traffic lane adjacent a first side of a road 1100, a first crossing zone 2200 configured to guide pedestrians from the waiting zone 2100 to a second side of the road 1100b, and a second crossing zone 2300 configured to guide pedestrians from the second side of the road 1100b to the first side of the road 1100a.

The waiting zone 2100 is located on and occupies the same area as the turning right receiving lane 1370 and, for example, also the turning left receiving lane 1360, but will only be used by pedestrians when these lanes are not in use, as will be described below.

The pedestrian crossing guidance system 4000 comprises a pair of pedestrian visual signaling devices 4100a, 4100b (see FIG. 10), located to either side of the road 1100a, 1000b, and a controller 4200.

The pedestrian visual signaling devices 4100 comprise a first pedestrian visual signaling device 4100a (see FIG. 9) located on side on the road 1100a, and a second pedestrian visual signaling device 4100b located on a second side of the road 1100b. The pedestrian visual signaling devices 4100a and 4100b are configured for safely directing pedestrians across at least one of the roads 1100 in the proximate region 1300, and, for example, along the first crossing zone 2200 and the second crossing zone 2300.

The pedestrian visual signaling devices 4100a, 4100b are operable in one of two modes, namely a go condition and a stop condition, similar to known pedestrian crossings.

In an exemplary embodiment, the pedestrian visual signaling devices 4100 will be controlled by the controller to guide pedestrians in synchronization with the visual signaling devices 3100 of the traffic guidance system 3000. In particular, the pedestrian visual signaling device 4100a is controlled by the controller 4200 to cause pedestrians to move across the first crossing zone 2200 towards the side of the road 1100a when vehicles in the turning left lane 1330, the going straight lane 1320, the going straight receiving lane 1350 and the turning right lane 1310 have been brought to a halt by the visual signaling devices 3100, and before the vehicles to be received into the turning left receiving lane 1360 and the turning right receiving lane 1370 from the intersecting road 1100 start moving.

It is envisaged that pedestrians will be afforded a small portion of time to start moving off the waiting zone 2100 before vehicles are guided to move into the turning left receiving lane 1360 and the turning right receiving lane 1370 from the intersecting road 1100.

Similarly, the pedestrian visual signaling device 4100b will be controlled by the controller to cause pedestrians to move from the side of the road 1100a towards the opposed side of the road 1100b via the second crossing zone 2300 when vehicles in the turning left lane 1330, the going straight lane 1320, the going straight receiving lane 1350 and the turning right lane 1310 have been brought to a halt by the visual signaling devices 3100. The pedestrian visual signaling device 4100b will allow for vehicles to be received into the turning left receiving lane 1360 and the turning right receiving lane 1370 from the intersecting road 1100 in guiding pedestrians across second crossing zone 2300.

It is envisaged that the timing of the visual signal being given to pedestrians by pedestrian visual signaling device 4100b to guide them across second crossing zone 2300 will be delayed to allow for vehicles turning into the turning left receiving lane 1360 and the turning right receiving lane 1370 to be received first. However, alternately, the timing of the visual signal given to pedestrians by the pedestrian visual signaling device 4100b can be initiated earlier on to allow pedestrians time to cross the road before vehicles received into these lanes.

The controller 4200 of the pedestrian crossing guidance system 4000 is envisaged as using the same processor and digital storage media as the traffic guidance system 3000. In this regard, software instructions stored on the digital storage media will direct operation of the pedestrian visual signaling devices 4100 between their two modes of operation.

With reference to FIGS. 18a and 18b again, movement of pedestrians across the pedestrian crossing is shown, while the pedestrian visual signaling devices are operable in one of two modes, to thereby guide pedestrians safely across the road. In this way, a pedestrian crossing 2000 and pedestrian guidance system, therefore, is provided that is operable in one of two modes to match the minimum number of modes possible with the corresponding traffic intersection 1000 and vehicle guidance system.

Directional Indicator Arrangement

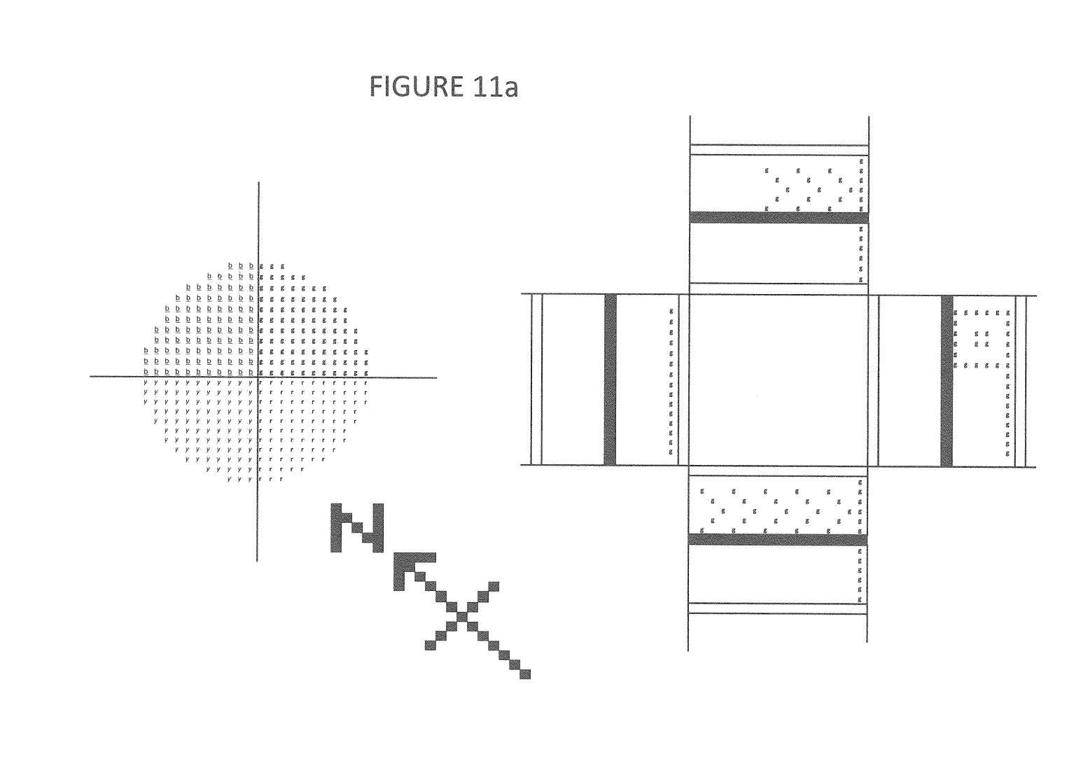

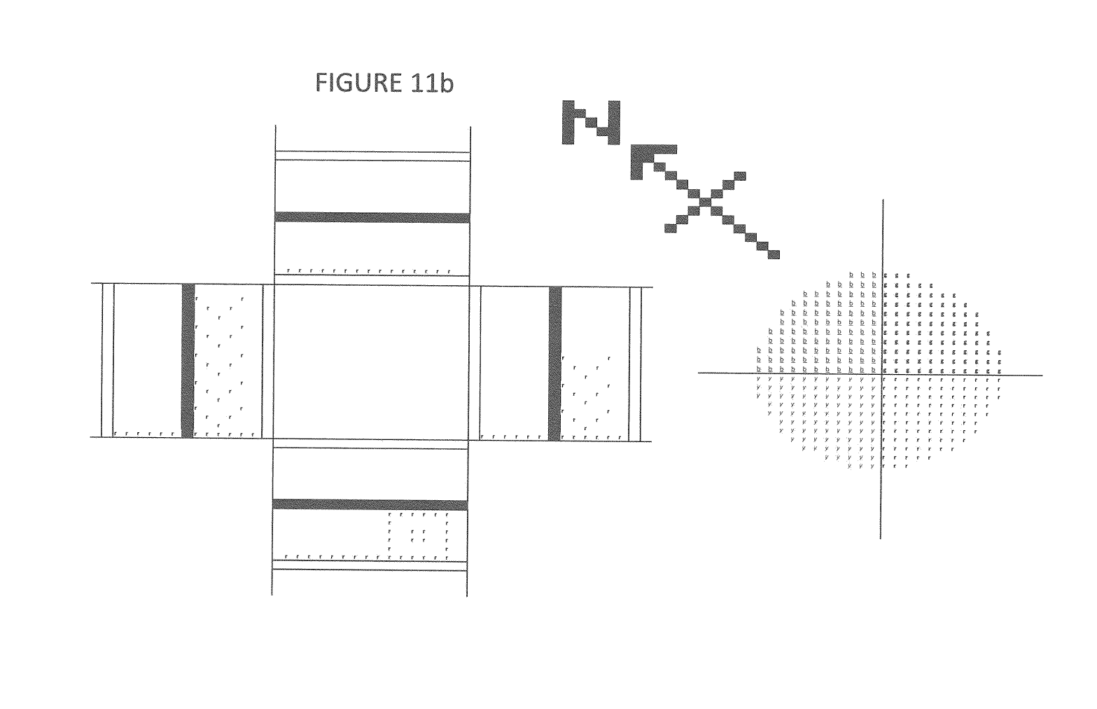

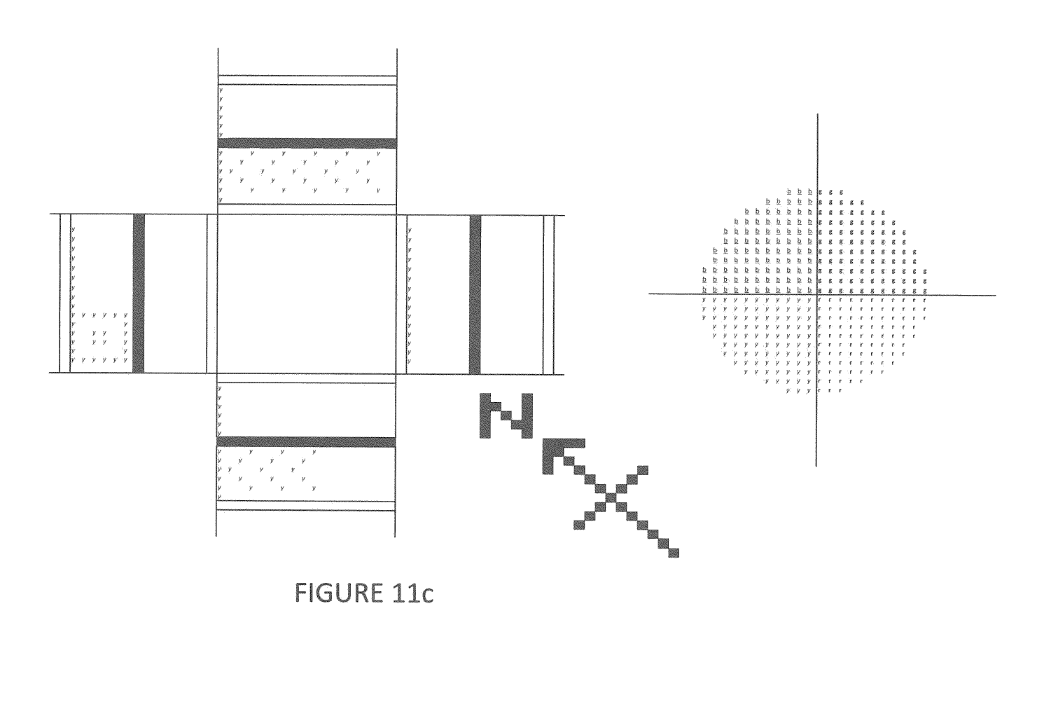

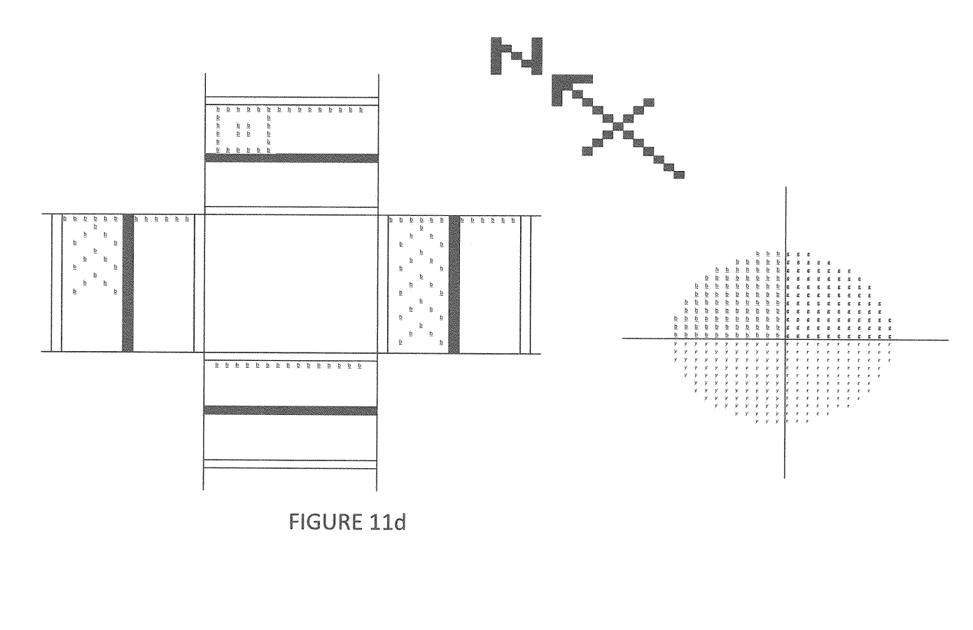

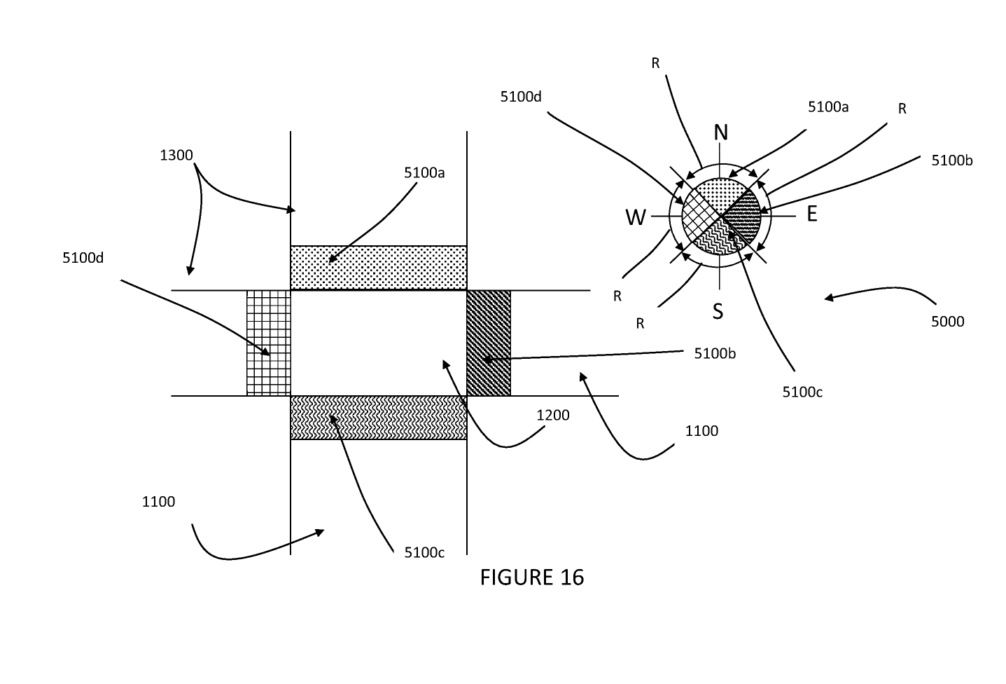

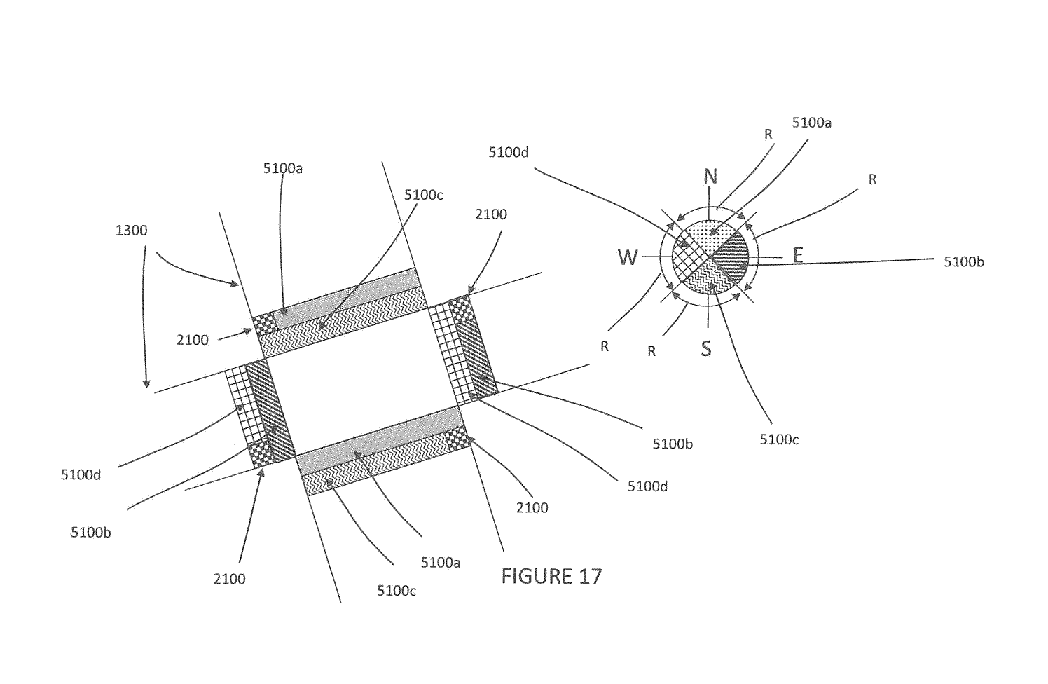

In another aspect, and as shown with specific reference to FIGS. 16 and 17, there is provided a directional indicator arrangement 5000 for use at an intersection of two roads 1100. The directional indicator arrangement 5000 comprises a traffic intersection being configured to display at least four marking protocols 5100a, 5100b, 5100c, 5100d, each one corresponding to a range of directions on a compass. Each marking protocol is indicative of a range of compass directions (shown as reference numeral R in FIGS. 16 and 17). In one embodiment, the marking protocols comprise at least four or more pre-allocated coloring or patterned protocols. In an exemplary embodiment, it is envisaged that a color will be assigned to each of the four compass directions, as well as a range extending to 45 degrees to either side of the main compass directions North, East, South and West. As shown in FIG. 11, the assigned pattern will preferably be painted across the width of the multilane road 1100 that extends in the range R of directions to which the marking protocol 5100 has been allocated.

It will be appreciated that many alternative forms of marking protocols possible. It will further be appreciated that traffic intersections can be marked by the marking protocol 5100 at many places. For example, as shown in FIG. 17, the marking protocol for opposed directions is repeated in each of the proximate regions 1300. It is further anticipated that where the directional indicator arrangement 5000 is used together with the traffic intersection 1000 described above, additional marking protocols may be used to consistently demarcate danger areas. This is shown in FIG. 17 where a consistent pattern is shown in a pedestrian waiting zone 2100.

As shown in the figures, each of the four proximate regions 1300 at an intersection of two roads 1100 will be color-coded to correspond to the direction in which the road extends away from the intersection region 1200.

In the embodiment shown in FIGS. 16 and 17, each range R of compass directions extends to 45 degrees of each of the main compass directions North, East, South and West. In this way, drivers of vehicles travelling along the roads 1100 will be able to tell which direction they are moving in by inspecting known protocols 4100 at any particular traffic intersection 1000.

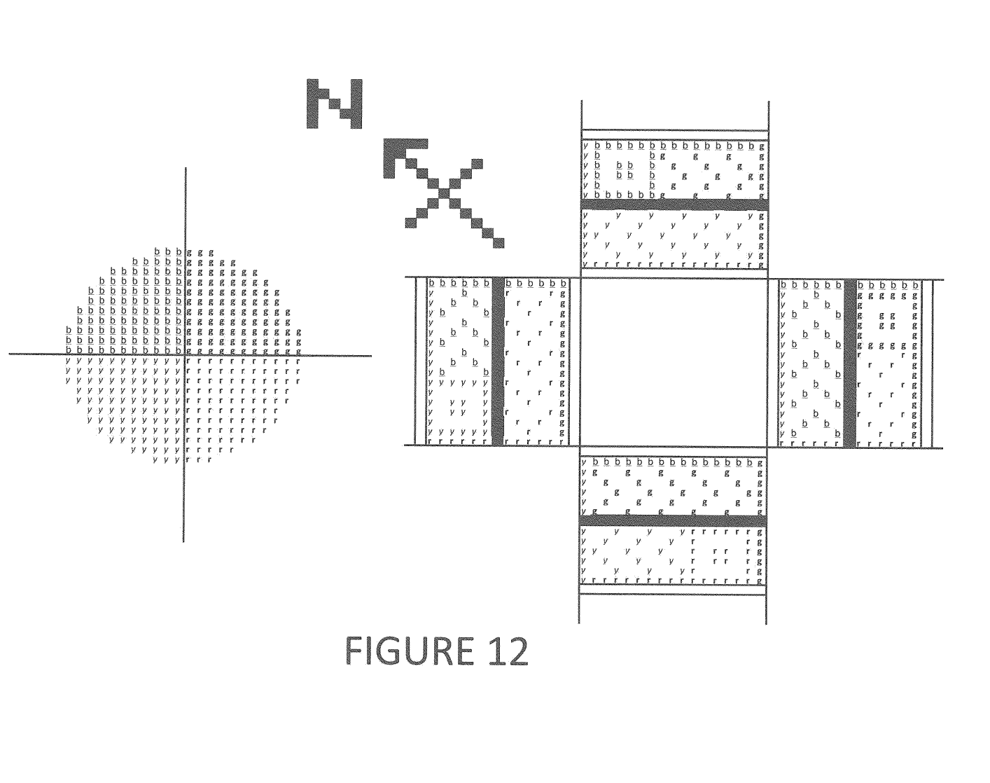

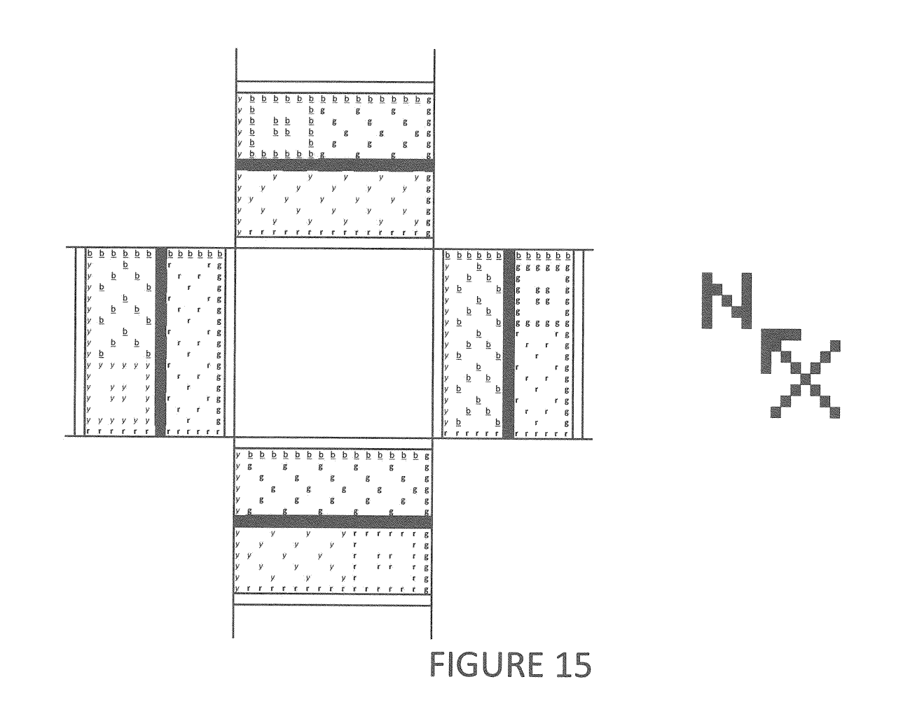

With reference to FIGS. 1 to 6 and 11 to 15, a more complex directional indicator arrangement 5000 is illustrated. The compass ranges are shown with reference to the first letter of the color that they are anticipated as being painted in—notably blue, green, red and yellow. In particular, for each directional range R, a correspondingly colored line will be marked across the pedestrian crossing 2000 part of the intersection 1000 on the side to corresponding to the compass range.

Further, where pedestrians are caused to move by a pedestrian visual signaling device 4100 in a direction corresponding to one of the compass ranges R, it is anticipated that an arrow design may be painted in the color corresponding to that compass range R.

Further, each of the pedestrian waiting zones 2100 will be marked a design of alternating white and colored concentric bands. The color of the colored bands will correspond to a compass range R. This is illustrated in FIGS. 11a to 11d for each of the colors.

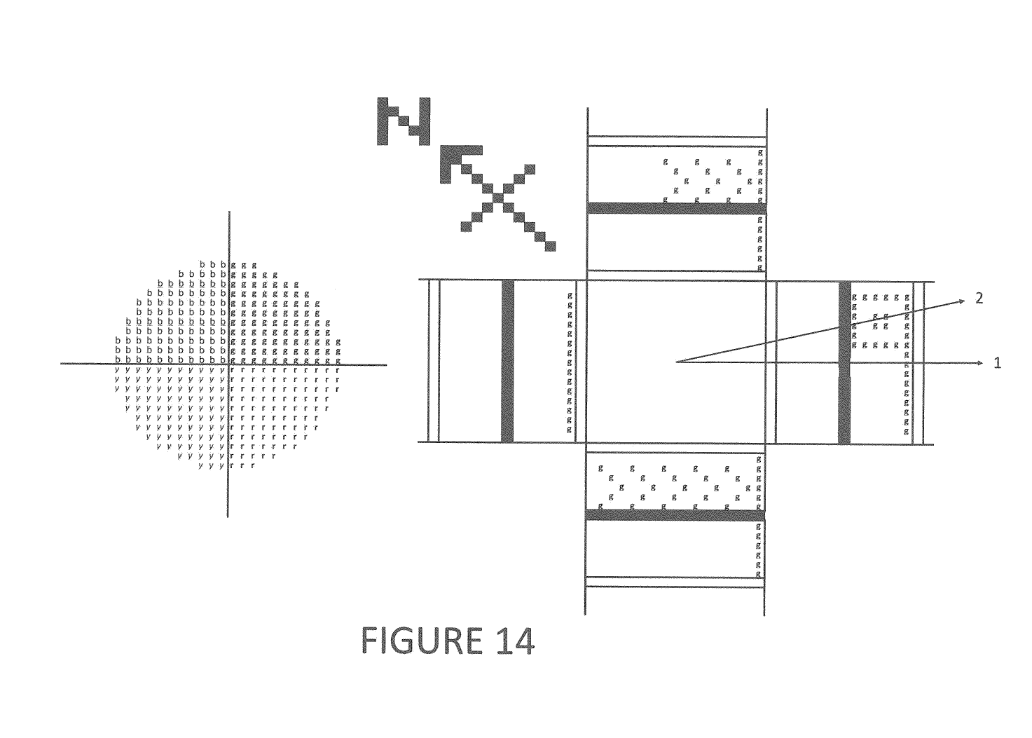

With reference to FIG. 14, two separate determination lines 1, 2 are provided to establish in which range R a particular road falls. It is anticipated that a two-stage method of determination will be used. In the first instance, a first determination line 1 will be taken from the center of the intersection down the middle of the road 1100. However, if this determination line corresponds too closely to an edge of the range of allocated compass directions R, then a second determination line 2 will be used. The second determination line 2 will extend from the center of the intersection through the middle of the pedestrian waiting zone 2100 of that road 1100. In an alternative arrangement, the first and second determination lines can be reversed.

Schematic FIGS. 18a and 18b show an intersection and pedestrian crossing operating in one of two modes in which both vehicles and pedestrians are guided to safely cross the intersection and roads respectively.

It is further envisaged that each pedestrian crossing can be provided with markings indicative of at least a portion of the street address of the closest building to that pedestrian crossing. Numbering on opposed sides of the pedestrian crossing can be provided that corresponds to, for example, even in odd numbered buildings starting from that corner of the intersection region. In this way, drivers driving down the roads will be able to establish where the address is that they are looking for by looking at the intersection is, rather than having their attention distracted by looking for address numbers on buildings at the side of the road.

It should be noted that a web server, client computing device and the computer readable storage medium provide the same or similar advantages as the advantages provided by the corresponding computer implemented method, some of which are described herein. Additionally the web server and/or client computing device provides the advantage of deployment across a computer network, such as the Internet, providing distribution, access and economy of scale advantages. Furthermore, the computer readable storage medium provides further advantages, such allowing the deployment of computer instructions for installation and execution by one or more computing devices.

Interpretation

In accordance with

As described herein, ‘in accordance with’ may also mean ‘as a function of’ and is not necessarily limited to the integers specified in relation thereto.

Composite Items As described herein, ‘a computer implemented method’ should not necessarily be inferred as being performed by a single computing device such that the steps of the method may be performed by more than one cooperating computing devices.

Similarly objects as used herein such as ‘web server’, ‘server’, ‘client computing device’, ‘computer readable medium’ and the like should not necessarily be construed as being a single object, and may be implemented as a two or more objects in cooperation, such as, for example, a web server being construed as two or more web servers in a server farm cooperating to achieve a desired goal or a computer readable medium being distributed in a composite manner, such as program code being provided on a compact disk activatable by a license key downloadable from a computer network.

Database

In the context of this document, the term database and its derivatives may be used to describe a single database, a set of databases, a system of databases or the like. The system of databases may comprise a set of databases wherein the set of databases may be stored on a single implementation or span across multiple implementations. The term database is also not limited to refer to a certain database format rather may refer to any database format. For example, database formats may include MySQL, MySQLi , XML or the like.

Wireless

The invention may be embodied using devices conforming to other network standards and for other applications, including, for example other WLAN standards and other wireless standards. Applications that can be accommodated include IEEE 802.11 wireless LANs and links, and wireless Ethernet.

In the context of this document, the term wireless and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. In the context of this document, the term wired and its derivatives may be used to describe circuits, devices, systems, methods, techniques, communications channels, etc., that may communicate data through the use of modulated electromagnetic radiation through a solid medium. The term does not imply that the associated devices are coupled by electrically conductive wires.

Processes

Unless specifically stated otherwise, as apparent from the following discussions, it is appreciated that throughout the specification discussions utilizing terms such as processing, computing, calculating, determining, analyzing or the like, refer to the action and/or processes of a computer or computing system, or similar electronic computing device, that manipulate and/or transform data represented as physical, such as electronic, quantities into other data similarly represented as physical quantities.

Processor

In a similar manner, the term processor may refer to any device or portion of a device that processes electronic data, e.g., from registers and/or memory to transform that electronic data into other electronic data that, e.g., may be stored in registers and/or memory. A computer or a computing device or a computing machine or a computing platform may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. The processing system further may include a memory subsystem including main RAM and/or a static RAM, and/or ROM.

Computer-Readable Medium

Furthermore, a computer-readable carrier medium may form, or be included in a computer program product. A computer program product can be stored on a computer usable carrier medium, the computer program product comprising a computer readable program means for causing a processor to perform a method as described herein.

Networked or Multiple Processors

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment. The one or more processors may form a web appliance, a network router, switch or bridge, or any machine capable of executing a set of instructions (sequential or otherwise) that specify actions to be taken by that machine.

Note that while some diagram(s) only show(s) a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Additional Embodiments

Thus, one embodiment of each of the methods described herein is in the form of a computer-readable carrier medium carrying a set of instructions, e.g., a computer program that are for execution on one or more processors. Thus, as will be appreciated by those skilled in the art, embodiments of the present invention may be embodied as a method, an apparatus such as a special purpose apparatus, an apparatus such as a data processing system, or a computer-readable carrier medium. The computer-readable carrier medium carries computer readable code including a set of instructions that when executed on one or more processors cause a processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

Carrier Medium

The software may further be transmitted or received over a network via a network interface device. While the carrier medium is shown in an example embodiment to be a single medium, the term carrier medium should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media.

Implementation

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

Means For Carrying out a Method or Function

Furthermore, some of the embodiments are described herein as a method or combination of elements of a method that can be implemented by a processor of a processor device, computer system, or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

Connected

Similarly, it is to be noticed that the term connected, when used in the claims, should not be interpreted as being limitative to direct connections only. Thus, the scope of the expression a device A connected to a device B should not be limited to devices or systems wherein an output of device A is directly connected to an input of device B. It means that there exists a path between an output of A and an input of B which may be a path including other devices or means. Connected may mean that two or more elements are either in direct physical or electrical contact, or that two or more elements are not in direct contact with each other but yet still co-operate or interact with each other.

Embodiments

Reference throughout this specification to one embodiment or an embodiment means that a particular feature, structure or characteristic described in connection with the embodiment is included in at least one embodiment of the present invention. Thus, appearances of the phrases in one embodiment or in an embodiment in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as forward, rearward, radially, peripherally, upwardly, downwardly, and the like are used as words of convenience to provide reference points and are not to be construed as limiting terms.

Different Instances of Objects

As used herein, unless otherwise specified the use of the ordinal adjectives first, second, third, etc., to describe a common object, merely indicate that different instances of like objects are being referred to, and are not intended to imply that the objects so described must be in a given sequence, either temporally, spatially, in ranking, or in any other manner.

Comprising and Including

In the claims which follow and in the preceding description of the invention, except where the context requires otherwise due to express language or necessary implication, the word comprise or variations such as comprises or comprising are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

Chronological Order

For the purpose of this specification, where method steps are described in sequence, the sequence does not necessarily mean that the steps are to be carried out in chronological order in that sequence, unless there is no other logical manner of interpreting the sequence.

Markush Groups

In addition, where features or aspects of the invention are described in terms of Markush groups, those skilled in the art will recognise that the invention is also thereby described in terms of any individual member or subgroup of members of the Markush group.

### INDUSTRIAL APPLICABILITY

It is apparent from the above, that the arrangements described are applicable to the traffic management industries.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The foregoing description and accompanying drawings illustrate the principles, exemplary embodiments, and modes of operation of the systems and methods. However, the systems and methods should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the systems and methods as defined by the following claims.

What is claimed is:

1. A traffic intersection located at an intersection of two multilane roads, each multilane road comprising a plurality of traffic lanes spaced one vehicle spacing apart, the traffic intersection comprising:
an intersection region wherein the surface area of the intersecting multilane roads overlap;
a crossover zone; and
a proximate region in which at least one multilane road approaching the intersection includes at least:
at least one turning left lane shaped to guide vehicles to turn right at the intersection onto the intersecting multilane road; and
at least one going straight lane shaped to guide vehicles to move straight through the intersection on the same multilane road,
the at least one turning left lane being configured to extend from the going straight lane at a distance from the at least one going straight lane in the proximate region by crossing through the crossover zone so that vehicles travelling straight through the intersection in an opposite direction along the same multilane road are guided to move between the at least one turning left lane and the at least one going straight lane.

2. The traffic intersection according to claim 1, wherein the proximate region comprises a going straight receiving lane that extends between the at least one turning left lane and the at least one the going straight lane to receive vehicles moving straight across the intersection region from an opposed side.

3. The traffic intersection according to claim 1, wherein each of the at least one going straight lane is configured to guide vehicles to move at least one or more vehicle spacing to the left as the respective vehicle moves over the intersection region.

4. The traffic intersection according to claim 1, wherein each of the at least one going straight lanes is configured to guide vehicles to the crossover zone distally of the intersection region to allow vehicles moving straight through the intersection region to cross the crossover zone while moving at least one vehicle spacing to the right.

5. The traffic intersection according to claim 1, wherein the proximate region further comprises at least one turning right lane shaped to guide vehicles to turn right at the intersection region onto the intersecting multilane road.

6. The traffic intersection according to claim 1, wherein the at least one going straight lane in the proximate region is also configured as a turning right lane shaped to guide vehicles to turn right at the intersection region onto the intersecting multilane road.

7. The traffic intersection according to claim 1, which further comprises visual signaling arrangements configured to safely direct vehicles on the roads through the intersection region.

8. The traffic intersection according to claim 1, wherein the proximate region further comprises at least one receiving lane configured to receive and guide one or both of:
vehicles turning left from the intersecting multilane road; and
vehicles turning right from the intersecting multilane road.

9. The traffic intersection according to claim 1, which further comprises a plurality of bicycle lanes configured to guide bicycles in opposed directions, bicycle lanes in a region distal to the crossover zone extending centrally along the multilane road.

10. The traffic intersection according to claim 9, which further comprises bicycle visual signaling arrangements configured to guide a bicycle in a bicycle lane safely through the intersection region.

11. The traffic intersection according to claim 1, which further comprises intermediate visual signaling arrangements configured to signal vehicles approaching the crossover zone.

12. The traffic intersection according to in claim 9, which further comprises intermediate bicycle visual signaling arrangements configured to signal bicycles approaching the crossover zone in a bicycle lane.

13. The traffic intersection according to claim 1, which further comprises a first crossover zone distal to the intersection region and a second crossover zone more proximate to the intersection region.

14. The traffic intersection according to claim 13, which further comprises at least one or more intermediate lanes extending between the second crossover zone and the first crossover zone.

15. The traffic intersection according to claim 13, which further comprises at least one or more bicycle intermediate lanes extending between the second crossover zone and the first crossover zone.

16. A guidance system for guiding traffic through the traffic intersection according to claim 1, with each road in the traffic intersection comprising a plurality of traffic lanes spaced one vehicle spacing apart, the system comprising
a turning left visual signaling device configured to signal towards the at least one turning left lane to guide vehicles to turn right at the intersection onto the intersecting multilane road;
a going straight visual signaling device configured to signal towards the at least one going straight lane to guide vehicles to move straight through the intersection on the same road, the turning left visual signaling device being distanced from a nearest going straight visual signaling device by at least two vehicle spacings; and
a signaling device controller controlling operation of the signaling devices.

17. The guidance system according to claim 16, which further comprises:
at least one turning right lane shaped to guide vehicles to turn right at the intersection onto the intersecting multilane road; and
a turning right visual signaling device configured to signal towards the at least one turning right lane to guide vehicles to turn right at the intersection onto the intersecting multilane road.

18. The guidance system according to claim 16, wherein the signaling device controller comprises:
a transmitter transmitting actuating instructions to at least one of the visual signaling devices;
digital storage media storing digital instructions that direct the signaling device controller to actuate at least one of the visual signaling devices; and
a processor operating to receive instructions from the digital storage media.

19. The guidance system according to claim 16, which further comprises bicycle visual signaling devices configured to signal to bicycles in bicycle lanes associated with the vehicle lanes.

20. The guidance system according to claim 16, wherein the crossover zone is located distally of the intersection and which further comprises intermediate visual signaling devices configured to signal to at least one of bicycles and vehicles approaching the crossover zone located distally of the intersection.

21. The guidance system according to claim 20, wherein the crossover zone comprises a first crossover zone distal to the intersection and a second crossover zone more proximal to the intersection, the first crossover zone and the second crossover zone being separated by intermediate guiding lanes, and which further comprises intermediate visual signaling devices configured to signal to at least one of vehicles and bicycles in the intermediate guiding lanes.

22. A traffic signaling arrangement for use at the traffic intersection according to claim 1, the traffic signaling arrangement comprising:
a first set of visual signaling devices configured to display a visual signal in a first direction to vehicles approaching the intersection, the visual signals including:
a left turn signal guiding alignment of vehicles desiring to turn left at the intersection; and
a receiving going straight signal guiding alignment of vehicles desiring to move straight through the intersection; and
a second set of visual signaling devices configured to display a visual signal in a second direction opposed to the first direction to vehicles moving through the intersection, the visual signals including:
a going straight signal guiding alignment of vehicles having moved to the intersection to continue moving straight on the same multilane road; and
a receiving left turn signal guiding alignment of vehicles moving through the intersection to turn left onto an intersecting multilane road.

23. A pedestrian crossing for guiding pedestrians across a road at the traffic intersection according to claim 1, the pedestrian crossing comprising
markings designating a pedestrian waiting zone;
markings designating a first pedestrian crossing zone; and
markings designating a second pedestrian crossing zone, the markings designating the pedestrian waiting zone being located at least partially on a lane for receiving vehicles turning left from an intersecting multilane road.

24. A pedestrian crossing guidance system for guiding pedestrians across a road at the traffic intersection according to claim 1, the pedestrian crossing guidance system comprising:
a first pedestrian visual signaling device configured to display a visual signal to a pedestrian at a pedestrian waiting zone located adjacent a first side of the road and at least partially on a lane for receiving vehicles turning left from an intersecting road to an opposed second side of the road; and
a second pedestrian visual signaling device configured display a visual signal to a pedestrian on the second side to move from the second side of the road to the first side of the road.

25. A directional indicator arrangement for the traffic intersection according to claim 1, the directional indicator arrangement comprising at least four marking protocols, each marking protocol being indicative of a range of compass directions.

26. A method of marking the traffic intersection according to claim 1 with a directional indicator arrangement, the method comprising marking each road adjacent the traffic intersection in a marking protocol corresponding to a range of compass directions.

27. A method of determining a marking protocol for the traffic intersection according to claim 1, the method comprising the steps of:
allocating a marking protocol to a range of compass directions;
allocating first determination lines at a traffic intersection between two consistent features of a traffic intersection;
determining a direction of the first determination line; and
marking the traffic intersection according to the marking protocol corresponding to the range of compass directions that the direction of the first determination line falls within.
